(19) United States
(12) Patent Application Publication
(10) Pub. No.: US 2009/0070550 A1
(43) Pub. Date: Mar. 12, 2009

(54) Operational dynamics of three dimensional intelligent system on a chip

(75) Inventor: Neal Solomon, Oakland, CA (US)

Correspondence Address: Neal Solomon, PO Box 21297, Oakland, CA, 94620, US

(73) Assignee: Solomon Research LLC, Oakland, CA (US)

(21) Appl. No.: 12/283,454

(22) Filed: Sep. 12, 2008

Related U.S. Application Data
(60) Provisional application No. 60/993,637, filed on Sep. 12, 2007.

(51) Int. Cl. G06F 15/80; G06F 9/30

(52) U.S. Cl. 712/15; 712/E09.016

(57) ABSTRACT

The invention pertains to a 3D intelligent SoC. The self-regulating data flow mechanisms of the 3D SoC are elucidated, particularly parallelization of multiple asynchronous 3D IC nodes and reconfigurable components. These behavioral mechanisms are organized into a polymorphous computing architecture with plasticity functionality. Software agents are employed for reprogrammable 3D SoC network operability. Metaheuristic algorithms are applied to solving MOOPs in the 3D SoC for continuous reprogrammability for multiple application environments.

### CROSS-REFERENCES TO RELATED APPLICATIONS

The present application claims the benefit of priority under 35 U.S.C. §119 from U.S. Provisional Patent Application Ser. No. 60/993,637, filed on Sep. 12, 2007, the disclosure of which is hereby incorporated by reference in their entirety for all purposes.

### FIELD OF INVENTION

The invention involves system on chip (SoC) and network on chip (NoC) semiconductor technology. The system is a three dimensional (3D) super computer on a chip (SCOC) and involves multiple processors on silicon (MPSOC) and a system on a programmable chip (SOPC). Components of the present invention involve micro-electro-mechanical systems (MEMS) and nano-electro-mechanical systems (NEMS). In particular, the reconfigurable components of the SoC are adaptive and represent evolvable hardware (EHW), consisting of field programmable gate array (FPGA) and complex programmable logic device (CPLD) architectures. The system has elements of intelligent microsystems that signify bio-inspired computing behaviors, exemplified in hardware-software interactivity. Because the system is a hybrid heterostructure semiconductor device that incorporates EHW, intelligent behaviors and synthetic computer interconnect network fabrics, the system is exemplar of polymorphous computing architecture (PCA) and cognitive computing.

### BACKGROUND

The challenge of modern computing is to build economically efficient chips that incorporate more transistors to meet the goal of achieving Moore's law of doubling performance every two years. The limits of semiconductor technology are affecting this ability to grow in the next few years, as transistors become smaller and chips become bigger and hotter. The semiconductor industry has developed the system on a chip (SoC) as a way to continue high performance chip evolution.

So far, there have been four main ways to construct a high performance semiconductor. First, chips have multiple cores. Second, chips optimize software scheduling. Third, chips utilize efficient memory management. Fourth, chips employ polymorphic computing. To some degree, all of these models evolve from the Von Neumann computer architecture developed after WWII in which a microprocessor's logic component fetches instructions from memory.

The simplest model for increasing chip performance employs multiple processing cores. By multiplying the number of cores by eighty, Intel has created a prototype teraflop chip design. In essence, this architecture uses a parallel computing approach similar to supercomputing parallel computing models. Like some supercomputing applications, this approach is limited to optimizing arithmetic-intensive applications such as modeling.

The Tera-op, Reliable, Intelligently Adaptive Processing System (TRIPS), developed at the University of Texas with funding from DARPA, focuses on software scheduling optimization to produce high performance computing. This model's “push” system uses data availability to fetch instructions, thereby putting additional pressure on the compiler to organize the parallelism in the high speed operating system. There are three levels of concurrency in the TRIPS architecture, including instruction-level parallelism (ILP), thread-level parallelism (TLP) and data-level parallelism (DLP). The TRIPS processor will process numerous instructions simultaneously and map them onto a grid for execution in specific nodes. The grid of execution nodes is reconfigurable to optimize specific applications. Unlike the multi-core model, TRIPS is a uniprocessor model, yet it includes numerous components for parallelization.

The third model is represented by the Cell microprocessor architecture developed jointly by the Sony, Toshiba and IBM (STI) consortium. The Cell architecture uses a novel memory “coherence” architecture in which latency is overcome with a bandwidth priority and in which power usage is balanced with peak computational usage. This model integrates a microprocessor design with coprocessor elements; these eight elements are called “synergistic processor elements” (SPEs). The Cell uses an interconnection bus with four unidirectional data flow rings to connect each of four processors with their SPEs, thereby meeting a teraflop performance objective. Each SPE is capable of producing 32 GFLOPS of power in the 65 nm version, which was introduced in 2007.

The MOrphable Networked Micro-ARCHitecture (MONARCH) uses six reduced instruction set computing (RISC) microprocessors, twelve arithmetic clusters and thirty-one memory clusters to achieve a 64 GFLOPS performance with 60 gigabytes per second of memory. Designed by Raytheon and USC/ISI from DARPA funding, the MONARCH differs distinctly from other high performance SoCs in that it uses evolvable hardware (EHW) components such as field programmable compute array (FPCA) and smart memory architectures to produce an efficient polymorphic computing platform.

MONARCH combines key elements in the high performance processing system (HPPS) with Data Intensive Architecture (DIVA) Processor in Memory (PIM) technologies to create a unified, flexible, very large scale integrated (VLSI) system. The advantage of this model is that reprogrammability of hardware from one application-specific integrated circuit (ASIC) position to another produces faster response to uncertain changes in the environment. The chip is optimized to be flexible to changing conditions and to maximize power efficiency (3-6 GFLOPS per watt). Specific applications of MONARCH involve embedded computing, such as sensor networks.

These four main high performance SoC models have specific applications for which they are suited. For instance, the multi-core model is optimized for arithmetic applications, while MONARCH is optimized for sensor data analysis. However, all four also have limits.

The multi-core architecture has a problem of synchronization of the parallel micro-processors that conform to a single clocking model. This problem limits their responsiveness to specific types of applications, particularly those that require rapid environmental change. Further, the multi-core architecture requires “thread-aware” software to exploit its parallelism, which is cumbersome and produces quality of service (QoS) problems and inefficiencies.

By emphasizing its compiler, the TRIPS architecture has the problem of optimizing the coordination of scheduling. This bottleneck prevents peak performance over a prolonged period.

The Cell architecture requires constant optimization of its memory management system, which leads to QoS problems.

Finally, MONARCH depends on static intellectual property (IP) cores that are limited to combinations of specified pre-determined ASICs to program its evolvable hardware components. This restriction limits the extent of its flexibility, which was precisely its chief design advantage.

In addition to SoC models, there is a network on a chip (NoC) model, introduced by Arteris in 2007. Targeted to the communications industry, the 45 nm NoC is a form of SoC that uses IP cores in FPGAs for reprogrammable functions and that features low power consumption for embedded computing applications. The chip is optimized for on-chip communications processing. Though targeted at the communications industry, particularly wireless communications, the chip has limits of flexibility that it was designed to overcome, primarily in its deterministic IP core application software.

Various implementations of FPGAs represent reconfigurable computing. The most prominent examples are the Xilinx Virtex-II Pro and Virtex-4 devices that combine one or more microprocessor cores in an FPGA logic fabric. Similarly, the Atmel FPSLIC processor combines an AVR processor with programmable logic architecture. The Atmel microcontroller has the FPGA fabric on the same die to produce a fine-grained reconfigurable device. These hybrid FPGAs and embedded microprocessors represent a generation of system on a programmable chip (SOPC). While these hybrids are architecturally interesting, they possess the limits of each type of design paradigm, with restricted microprocessor performance and restricted deterministic IP core application software. Though they have higher performance than a typical single core microprocessor, they are less flexible than a pure FPGA model.

All of these chip types are two dimensional planar micro system devices. A new generation of three dimensional integrated circuits and components is emerging that is noteworthy as well. The idea to stack two dimensional chips by sandwiching two or more ICs using a fabrication process required a solution to the problem of creating vertical connections between the layers. IBM solved this problem by developing “through silicon vias” (TSVs) which are vertical connections “etched through the silicon wafer and filled with metal.” This approach of using TSVs to create 3D connections allows the addition of many more pathways between 2D layers. However, this 3D chip approach of stacking existing 2D planar IC layers is generally limited to three or four layers. While TSVs substantially limit the distance that information traverses, this stacking approach merely evolves the 2D approach to create a static 3D model.

In U.S. Pat. No. 5,111,278, Echelberger describes a 3D multi-chip module system in which layers in an integrated circuit are stacked by using aligned TSVs. This early 3D circuit model represents a simple stacking approach. U.S. Pat. No. 5,426,072 provides a method to manufacture a 3D IC from stacked silicon on insulation (SOI) wafers. U.S. Pat. No. 5,657,537 presents a method of stacking two dimensional circuit modules and U.S. Pat. No. 6,355,501 describes a 3D IC stacking assembly technique.

Recently, 3D stacking models have been developed on chip in which several layers are constructed on a single complementary metal oxide semiconductor (CMOS) die. Some models have combined eight or nine contiguous layers in a single CMOS chip, though this model lacks integrated vertical planes. MIT's microsystems group has created 3D ICs that contain multiple layers and TSVs on a single chip.

3D FPGAs have been created at the University of Minnesota by stacking layers of single planar FPGAs. However, these chips have only adjacent layer connectivity.

3D memory has been developed by Samsung and by BeSang. The Samsung approach stacks eight 2-Gb wafer level processed stack packages (WSPs) using TSVs in order to minimize interconnects between layers and increase information access efficiency. The Samsung TSV method uses tiny lasers to create etching that is later filled in with copper. BeSang combines 3D package level stacking of memory with a logic layer of a chip device using metal bonding.

See also U.S. Pat. No. 5,915,167 for a description of a 3D DRAM stacking technique, U.S. Pat. No. 6,717,222 for a description of a 3D memory IC, U.S. Pat. No. 7,160,761 for a description of a vertically stacked field programmable nonvolatile memory and U.S. Pat. No. 6,501,111 for a description of a 3D programmable memory device.

Finally, in the supercomputing sphere, the Cray T3D developed a three dimensional supercomputer consisting of 2048 DEC Alpha chips in a torus networking configuration.

In general, all of the 3D chip models merely combine two or more 2D layers. They all represent a simple bonding of current technologies. While planar design chips are easier to make, they are not generally high performance.

Prior systems demonstrate performance limits, programmability limits, multi-functionality limits and logic and memory bottlenecks. There are typically trade-offs of performance and power.

The present invention views the system on a chip as an ecosystem consisting of significant intelligent components. The prior art for intelligence in computing consists of two main paradigms. On the one hand, the view of evolvable hardware (EHW) uses FPGAs as examples. On the other hand, software elements consist of intelligent software agents that exhibit collective behaviors. Both of these hardware and software aspects take inspiration from biological domains.

First, the intelligent SoC borrows from biological concepts of post-initialized reprogrammability that resembles a protein network that responds to its changing environmental conditions. The interoperation of protein networks in cells is a key behavioral paradigm for the iSoC. The slowly evolving DNA root structure produces the protein network elements, yet the dynamics of the protein network are interactive with both itself and its environment.

Second, the elements of the iSoC resemble the subsystems of a human body. The circulatory system represents the routers, the endocrine system is the memory, the skeletal system is comparable to the interconnects, the nervous system is the autonomic process, the immune system provides defense and security as it does in a body, the eyes and ears are the sensor network and the muscular system is the bandwidth. In this analogy, the brain is the central controller.

For the most part, SoCs require three dimensionality in order to achieve high performance objectives. In addition, SoCs require multiple cores that are reprogrammable so as to maintain flexibility for multiple applications. Such reprogrammability allows the chip to be implemented cost effectively. Reprogrammability, moreover, allows the chip to be updatable and future proof. In some versions, SoCs need to be power efficient for use in embedded mobile devices. Because they will be prominent in embedded devices, they also need to be fault tolerant. By combining the best aspects of deterministic microprocessor elements with indeterministic EHW elements, an intelligent SoC efficiently delivers superior performance.

While the design criteria are necessary, economic efficiency is also required. Computational economics reveals a comparative cost analysis that includes efficiency maximization of (a) power, (b) interconnect metrics, (c) transistor per memory metrics and (d) transistor per logic metrics.

Problems that the System Solves

Optimization problems that the system solves can be divided into two classes: bi-objective optimization problems (BOOPs) and multi-objective optimization problems (MOOPs).

BOOPs consist of trade-offs in semiconductor factors such as (a) energy consumption versus performance, (b) number of transistors versus heat dissipation, (c) interconnect area versus performance and (d) high performance versus low cost.

Regarding MOOPs, the multiple factors include: (a) thermal performance (energy/heat dissipation), (b) energy optimization (low power use), (c) timing performance (various metrics), (d) reconfiguration time (for FPGAs and CPLDs), (e) interconnect length optimization (for energy delay), (f) use of space, (g) bandwidth optimization and (h) cost (manufacture and usability) efficiency. The combination of solutions to trade-offs of multiple problems determines the design of specific semiconductors. The present system presents a set of solutions to these complex optimization problems.

One of the chief problems is to identify ways to limit latency. Latency represents a bottleneck in an integrated circuit when the wait to complete a task slows down the efficiency of the system. Examples of causes of latency include interconnect routing architectures, memory configuration and interface design. Limiting latency problems requires the development of methods for scheduling, anticipation, parallelization, pipeline efficiency and locality-priority processing.

### SUMMARY

The architecture of a system on a chip (SoC) provides the main structure of the circuitry, but the functioning of the chip is critical for providing operational effectiveness. There are numerous advantages to a 3D multi-functional reconfigurable SoC. First, the 3D iSoC operation is asymmetric because its various parts operate independently. Second, it is highly parallel and has multiple interoperational parts that function simultaneously. Third, it is self-regulating, with variable modulation of activities. Fourth, it is reconfigurable. Finally, it exhibits polymorphous computing behaviors for continuous reorganization plasticity.

There are two sources of polymorphous computing. One of the sources of polymorphous computing is flexible hardware reconfiguration such as in a CPLD or FPGA. The second source of polymorphous computing is based on flow control. The present invention describes the distinctive features of the 3D iSoC pertaining to functional dynamics.

The iSoC uses a multi-agent system (MAS) to coordinate the collective behaviors of software agents to perform specific actions to solve problems. This integrated software system automates numerous iSoC operations, including self-regulation and self-diagnosis of multiple autonomic regulatory functions and the activation of multiple reconfigurable, and interactive, subsystems.

Intelligent mobile software agents (IMSAs) cooperate, collaborate and compete in order to solve optimization problems in the 3D iSoC. Since the system nodes operate autonomously within the various subsystems, the IMSAs perform numerous functions from communication to decision-making in parallel.

The system uses a library of metaheuristics to perform specific actions and to solve complex MOOPs. These metaheuristics include hybrid evolutionary computation algorithms, swarm intelligence algorithms, local search algorithms and artificial immune system algorithms. These learning techniques are applied to optimization problems in the framework of a reconfigurable polymorphous computing architecture.

The operational aspects of the present invention involve self-regulating flow, variable internodal functionality, independent nodal operation, hybrid interaction of hardware and software, asynchronous clocking between clusters and spiking flows for plasticity behaviors. Novel metaheuristics are applied to solve BOOPs and MOOPs, by using modeling scenarios. The present system also employs predictive techniques for optimal routing. Finally, the system uses software agents to perform collective behaviors of automated programming.

### Novelties

The system uses metaheuristics to guide hardware evolution. In particular, it uses a hybrid artificial immune system to model chip optimization to solve MOOPs. The system also uses autonomic computing processes to regulate chip functions.

The chip has sufficient redundancy with multiple nodes to be fault tolerant: If one node is damaged, others remodulate the system and perform tasks.

Software agents perform numerous coordinated functions in the chip. The pro-active adaptive operation of the chip that provides its evolvable characteristics is facilitated by a combination of novel features involving software agents to solve MOOPs.

The combination of iSoCs into networks produces a flexible high performance system that exhibits self-organizing behaviors.

### Advantages of the Present System

The system uses metaheuristic optimization algorithms for hyper-efficiency. The self-regulating aspects of network logic are applied to the unified 3D iSoC. The combination of novel features in the iSoC allows it to perform autonomous functions such as the internal autonomic computer network functions of self-diagnosis, self-regulation, self-repair and self-defense.

This 3D iSoC disclosure represents a second generation of polymorphous computing architecture (PCA).

Programmability in the present invention involves the employment of software agents, which exhibit collective behaviors of autonomous programming. This feature allows the reprogrammable nodes to be coordinated and self-organized. Further, this allows the scaling of multiple iSoCs in complex self-organizing networks.

Because of its modular characteristics, the current system is fault tolerant. If part of the system is dysfunctional, other parts of the system modulate their functionality for mission completion.

### DESCRIPTION OF THE INVENTION

### 3D Intelligent SoC Operational Dynamics

The disclosure describes solutions to problems involving operational functionality in a 3D iSoC, particularly involving parallelization, integration of multiple reprogrammable and self-assembling components, and dynamics.

(1) Independent Operation of Nodes in 3D SoC

Each node in the 3D SoC functions independently. The multiple processing nodes in a neighborhood cluster operate as “organs” performing specific functions at a particular time. There are interoperational efficiencies of using a parallel multi-node on-chip computing system, particularly massive parallelism in a single iSoC.

The use of a combination of multiple nodes in the iSoC provides overall multi-functionality, while the iSoC performs specific functions within each neighborhood cluster. The iSoC's multi-functional network fabric uses multiple computer processing capabilities that produce superior performance and superior flexibility compared to other computing architectures. These processes are optimized in the 3D environment.

(2) Variable Operation of Asymmetric Node Clusters in 3D SoC

The composition of each neighborhood cluster varies for each task. Algorithms are employed to configure the composition of neighborhood clusters from the potential node configuration in order to optimize the overall system performance of the 3D iSoC. Because the node composition of the neighborhood clusters periodically changes, each octahedron sector has jurisdictional autonomy for control of reconfigurability of its component structures. While the node clusters periodically reassemble their cluster configurations, the nodes in the neighborhood clusters are coordinated to operate together.

Whole sections of the 3D iSoC can be offline, or minimally active, and the chip fabric adjusts. These collective effects of several neighborhood sections produce aspects of plasticity behavior.

Several nodes in a neighborhood are synchronized. The neighborhood then adds nodes in adjoining regions as needed on-demand to solve MOOPs. Each neighborhood cluster continuously restructures by synchronizing the added nodes. Specific operations are emphasized at one equilibrium point in a process and then shifted at another equilibrium point.

One advantage of using this operational model is that specific dysfunctional processor nodes can be periodically taken off line and then the overall system rapidly reroutes around these nodes. The system is therefore continuously rebalancing its load, both within individual neighborhoods and across all neighborhoods in the chip. This rebalancing capability provides a critical redundancy that allows for fault tolerance in order to overcome limited damage to parts of the chip.

(3) Central Node Activation of Multiple Nodes in 3D SoC Internode Network

Though the 3D iSoC has a cubic structure with octagonal neighborhood configuration, the central node affects internodal activation. The role of the central node is to regulate the neighborhood nodes, as a system manager. The neighborhood subsystems are autonomous clusters that interact with the central node to obtain instructions and to provide periodic operational updates.

Activation of computational processes in the central node affects the operational function of the neighborhood nodes. The central node has greater computational capacity than other individual nodes in the iSoC and controls the eight neighborhood clusters consisting of a total of 34 nodes.

The central node receives data inputs from nodes in neighborhood clusters. The central node also sends data and instructions to the nodes in the neighborhood clusters. The interactions between the cluster nodes and the central node create a dynamic process.

(4) Polymorphous Computing Using Simultaneous Multi-Functional 3D IC Operation in Reconfigurable 3D SoC

Polymorphous computing involves the operation of multiple reconfigurable circuits in a SoC fabric. Polymorphous computing allows an SoC's rapid adaptation to uncertain and changing environments.

The 3D iSoC exhibits polymorphous computing functionality because it (a) uses multiple reconfigurable hardware components in the form of multiple interacting FPGA nodes and (b) employs a control flow process that exhibits reconfigurable behaviors. The iSoC continuously reprograms multiple simultaneous operations in the various neighborhood nodes to optimize functionality. The continuous optimization and reprioritization of multiple operations enable the iSoC to engage in multi-functional behaviors and to solve multiple MOOPs concurrently.

An analogy to the iSoC multifunctional operation is a symphony, which exhibits unified coordinated operation to successfully achieve an objective. The multiple parts of the iSoC continuously harmonize by achieving multiple equilibrium points in a progression of computational stages to solve complex problems.

The subsystems in the neighborhood clusters of the iSoC engage in multiple simultaneous prototyping by continuously reconfiguring their evolvable hardware nodes. Though the overall chip fabric is seen as an integrated system, the neighborhood clusters are scalable and variable in composition, like a subdivision that builds out and then recedes, in order to modulate the circuitry work flow demands.

(5) Self-Regulating Flow Mechanisms for Polymorphous Computing in a 3D SoC

Polymorphous computing requires modulation of the work flow between multiple interoperating flexible computing nodes. The 3D iSoC network fabric constantly reprioritizes tasks to auto-restructure operational processes in order to optimize task solutions. The system continuously routes multiple tasks to various nodes for the most efficient processing of optimization solutions. Specifically, the system sorts, and resorts, problems to various nodes so as to obtain solutions. The system is constantly satisfying different optimality objectives and reassigning problems to various nodes for problem solving. At the same time, the reconfigurable nodes constantly evolve their hardware configurations in order to optimize these solutions in the most efficient ways available.

The closest available node has routed the highest priority problem routed to it. In addition, specific problem types are matched to the closest available node that can supply a particular computing capability to optimally solve these problems.

The challenge for the central node is to efficiently route traffic flows to various parts of the iSoC. The central node constantly tracks the present configuration of the evolving nodes and routes problems to each respective node to match its configuration.

If the nodes require transformation in order to optimize the solutions, the neighborhood nodes will reconfigure. The continuous plasticity effects of the changing solution requirements for solving MOOPs in the iSoC network fabric create a complex adaptive process. Overall, the iSoC network is a self-regulating system that unifies numerous operational techniques.

(6) Variable Modulation in 3D SoC Asynchronous Clocking Architecture

Since the neighborhood clusters all operate independently, they use variable clock rates. This clock rate variability between nodes allows a tremendous benefit in voltage modulation to match the operational rate. When the work load is moderate, the clocks modulate to a minimal rate so as to save energy, while at peak work load, the clocks spike to maximum working rates. This variable modulation of clocking usefully segregates the individual neighborhood clusters as they operate autonomously.

The linkage of the neighborhoods occurs via the use of a globally asynchronous locally asynchronous (GALA) process. In this model, whole neighborhoods may become dormant when the load does not require their activity, while the overall system remodulates the iSoC network fabric as demand warrants. The variable clocking of each autonomous neighborhood, and node, calibrates the asynchronous components of the iSoC network system as a whole.

The GALA system is used to connect the various neighborhoods to each other and to the central node. The overall iSoC clock speed is an aggregate of the modulating clocking rates of the various neighborhoods.

(7) Hybrid Parallelization for Concurrent Operations in 3D SoC Using Task Graphs

The use of multiple computational nodes in the 3D iSoC network fabric constitutes a highly parallel system. The benefits of computational parallelism lie in the dividing of tasks into manageable units for simultaneous computability and faster results. Initially, the present invention uses global level parallelization that is coarse-grained and focuses on dividing tasks to the specific neighborhood clusters. At a more refined level, the system uses node-level parallelization that is fine-grained in order to solve MOOPs. The combination of the global and the local levels produces a hybrid parallelization for concurrent operations. In one embodiment of the invention, MOOPs are divided into multiple BOOPs, which are then allocated to specific nodes for rapid parallel problem solving.

The system uses task graphs to assign optimization problems to specific neighborhoods and nodes. The list of problem-based priorities is scheduled in the task graphs, which are then matched to a specific node in a particular configuration. As the nodes periodically reconfigure on-demand in order to more efficiently perform tasks or solve MOOPs, the task graphs are updated with new information on the availability of new node configurations. Since the process is evolutionary, the task graphs constantly change. The task graphs require continuous rescheduling in order to accommodate the changing node reconfigurations. The particular challenge of the task graph logic is to efficiently specify the concurrency of tasks across the 3D iSoC network fabric as the system continuously recalibrates.

As one neighborhood simulates the optimal operations and schedule of the performance of an operation, it updates the task graph system. This scheduling process itself stimulates the continuous transformation of the evolvable hardware in the individual nodes. This process is co-evolutionary and further adaptive to a changing environment, thereby satisfying polymorphous computing constraints.

(8) Accelerated Transformation of Reconfigurable Application Layer of Node in 3D SoC

Each node consists of multiple circuit layers in a 3D configuration. The application layer reflects the specific functionality of each computational node. Since nodes in the 3D iSoC are reconfigurable, the transformation of the application layer in these EHW nodes is organized so they perform their functions in an accelerated way. Specifically, the application layer is the fastest, and simplest, to structurally modify. In some rapid transformation cases, the reconfigurable application layer is the only layer that is modified. In other cases, the application layer is transformed first, and the other layers are modified later.

This accelerated transformation of the reconfigurable application layer of a node in a 3D SoC is useful for more efficiently processing specific applications. This process allows the rapid reprogrammability of nodes in the iSoC on demand.

By calibrating the transformation of the application layers of multiple reconfigurable nodes, the system further accelerates continuous sequential reprogrammable features of the 3D iSoC network.

(9) Internodal Coordination of Spiking Flows for Plasticity in 3D SoC

The 3D iSoC network fabric is constantly readjusting for optimum self-organization by coordinating program instructions with external feedback. The chip exhibits intelligence and is active rather than static and passive.

The SoC performs plasticity behaviors by continuously modulating the functionality of the reconfigurable hardware components. As the subsystems are continuously modulated, the overall system exhibits plasticity.

While the system is rarely at peak performance over a continuous period of time, the flow of network traffic behaviors periodically spike within specific neighborhoods at peak capacity. Though spiking occurs in key nodes at key times, the system constantly modulates load-balancing between neighborhood clusters.

In this sense, the 3D iSoC overall emulates aspects of neural network behaviors.

### 3D Intelligent SoC Software Behaviors

The present disclosure presents solutions to problems involving software components in a 3D iSoC, including instruction parallelization, metaheuristic applications and MAS automation.

(1) Multi-Agent System Applied to 3D SoC

Intelligent mobile software agents (IMSAs) are software code that moves from one location in a network to another location. IMSAs are organized in collectives in a multi-agent system (MAS) to coordinate behaviors in the 3D iSoC. Specifically, IMSAs coordinate the functions of the multiple circuit nodes in the SoC network. IMSAs guide FPGA behaviors and coordinate the functions of reconfigurable nodes. IMSAs anticipate and model problems by using stochastic processes.

Each node has its own IMSA collective that performs routine functions of negotiating with other nodes IMSA collectives.

In most cases, cooperating IMSAs coordinate non-controversial functions of the iSoC. In solving more complex optimization problems that require decisions, competitive IMSAs negotiate solutions between nodes to satisfy goals. Competitive IMSAs use stochastic processes to negotiate using an auction model in a time-sensitive environment.

IMSAs in the MAS represent an intermediary layer of software functionality between the higher level abstract language and the application level operations. A compiler is integrated into each node to process the IMSA code as well as higher and lower level software languages. First order predicate logic is also applied to IMSAs.

(2) Coordination of Internodal Network for Compiler Architecture by Routing Code to Parallel Asynchronous Nodes in 3D SoC

The coordination of intra-nodal compilers in the parallel network provides routing solutions to software code in the SoC. While each node has the ability to compile some software code, each neighborhood uses a node compiler to coordinate the behaviors of its entire cluster. The neighborhood compiler uses asynchronous routing to continuously optimize the software routing process to multiple parallel nodes within the neighborhood cluster and between neighborhood routers. On the one hand, the neighborhood compilers divide up the IMSA functions to specific nodes as code is pushed from the neighborhood router to the nodes. On the other hand, IMSAs are coordinated and unified in the neighborhood compiler as they arrive from the individual neighborhood nodes.

Each compiler uses a metaheuristics engine to generate specific hybrid learning algorithms to solve MOOPs and then to route the IMSAs with instructions to specific locations based on the metaheuristic algorithm solutions.

(3) Autonomic Computing in 3D SoC Using Software Agents

Autonomic computing emulates the human autonomic nervous system in which specific regulatory functions such as heartbeat, breathing and swallowing are automatically coordinated. Autonomic computing models that emphasize the self-diagnosis, self-repair and self-defense of network systems have been applied to the network computing environment.

Autonomic computing is applied in the present system to the network fabric of the 3D iSoC primarily for the self-diagnosis and self-regulation of multiple parallel internal SoC functions.

By using sensors that are embedded into individual node circuits, the SoC performs continuous self-assessment procedures. The individual nodes keep an assessment record of all events and record them to internal memory. This process is useful for the purpose of tracking the operational record of indeterministic FPGA performance.

Autonomic computing is particularly useful for self-defense. By employing metaheuristics that emulate the human immune system, hybrid artificial immune system (AIS) processes are able to anticipate, detect, defend and eliminate malicious code and to provide strong network security mechanisms.

The autonomic computing processes are integrated into the SoC by collectives of IMSAs to provide self-regulatory functions. These SoC regulatory processes are centered in the central master node in order to consolidate the processes of the various neighborhood clusters.

The combination of multiple autonomic computing solutions applied to the 3D iSoC represents a form of self-awareness or cognitive intelligence in a network computing fabric on a chip.

(4) Metaheuristics for Solving Multi-Objective Optimization Problems in 3D SoC

The present system addresses the challenge of solving multiple aggregate optimization problems. The 3D iSoC is useful for solving multiple parallel MOOPs. In dynamic environments, the optimal solution changes as the conditions change. The best way to solve optimization problems in this context is to employ multiple parallel reconfigurable processing elements that interact with each other and with the environment. The iSoC makes continuous attempts to find techniques that provide solutions to evolving MOOPs.

By simultaneously employing multiple hybrid metaheuristics to continually optimize operations, the iSoC is more likely to achieve its MOOPs objectives within critical timing constraints.

The iSoC employs a library of hybrid and adaptive metaheuristics algorithms to test various learning techniques to solve MOOPs on-demand. MOOP solution options are constantly pruned as the set of families of options evolve given changing conditions and objectives. The system constantly seeks the best set of options to satisfy multiple changing constraints generated both by the evolving system itself and the evolving environment.

Metaheuristics are particularly useful when applied to evolutionary hardware (EHW). The FPGAs in the SoC are continuously tuned by applying metaheuristics algorithms to solve optimization problems.

Metaheuristic techniques that are employed in the iSoC include genetic algorithms, local search (tabu search, scatter search and adaptive memory programming), swarm intelligence (ant colony optimization [ACO], particle swarm optimization [PSO] and stochastic diffusion search [SDS]), and artificial immune system (AIS) algorithms. Each of these metaheuristics algorithms solves a different type of optimization problem, and each has a strength and weakness. Combining the best elements of each of these models, including hybrid configurations, with the use of the metaheuristics library allows the IMSAs in the network fabric of the 3D iSoC to accomplish a broad range of tasks and to offer solutions to many optimization problems.

Various metaheuristic algorithms are used simultaneously by the parallel processes of the 3D iSoC. Different nodes employ various metaheuristics in parallel in order to solve MOOPs within time constraints. For example, multiple FPGA nodes use metaheuristics to guide their reprogramming functions. These functions are coordinated, and the iSoC shares tasks collectively and continuously modifies its programming functions as the process continues to task conclusion. Multi-node optimization of operational functions is a specific feature of the iSoC that presents computing advantages.

The use of parallel optimization approaches is particularly useful in specific applications that involve arithmetic intensivity such as scientific and financial modeling.

(5) Reprogrammable Network Pathways in 3D SoC

Reprogrammable circuits present challenges for the development of methods and stimulus for reconfiguration, particularly in indeterministic self-organizing systems. The coordination of activities between multiple asynchronous FPGAs in an iSoC is particularly complex. Once an FPGA restructures its circuitry, its most recent EHW architecture configuration and functionality are transmitted to other circuits in its own neighborhood cluster and in the iSoC globally. Information about the reconfigurable situations of the various reprogrammable circuits at a specific time is organized by IMSAs that continuously monitor and share information between nodes.

IMSAs are useful in applying metaheuristic algorithms to train reconfigurable circuits. As FPGAs are trained, information about their configurations is transmitted by IMSAs to other reconfigurable circuits. The system shares tasks, particularly within neighborhood clusters, between multiple reconfigurable nodes that divide the tasks, reprogram multiple hardware components and continuously evolve hardware configurations in order to solve MOOPs.

In the course of this process of coordinating multiple FPGAs, IMSAs establish network pathways that are continuously optimized and shift based on the changing data traffic flows. The system globally produces plasticity behaviors by reorganizing the network paths to accommodate the continuously reconfigurable circuits. This process leads to indeterministic asynchronous reprogrammability that allows the system to solve complex problems in real time.

In particular, the process of using reprogrammable network pathways promotes multi-functional applications in which several processes are concurrently optimized. The multiple transforming circuits in the 3D iSoC present complex self-organizing dynamic processes for continuous plasticity.

(6) Predictive Elements to Anticipate Optimal Network Routing

Because the iSoC provides extremely rapid data throughput by using multiple continuously reconfigurable circuits, solving optimization problems in real time requires anticipatory behaviors. In the context of network computing, the system anticipates the most effective computing process by identifying and modeling a problem, planning the optimal routing to minimize bottlenecks and revising the schedule to actually route the data. The system anticipates problems to solve and solution options.

Anticipatory processes are developed by the iSoC via analysis and modeling of past processes. In the context of network routing, the past routing practices are assessed so they may provide the foundation for anticipating the best solution for future problems.

(7) Optimizing Traffic Flows in 3D SoC Operation

The multiple simultaneous reprogrammable features of the 3D iSoC illustrate the polymorphous computing architecture advantages of the present system. As multiple FPGAs continuously reorganize their hardware attributes, they send signals to other circuits to perform EHW functions. These processes use IMSAs to carry messages between nodes and to coordinate functions. IMSAs cooperate and compete in order to perform specific multi-functional tasks. IMSAs employ metaheuristics in order to solve parallel MOOPs on-demand.

While IMSAs are the messengers and metaheuristics are the analytical components, IP cores are the units of software that enable specific FPGAs to perform specific operations. IP core elements are accessed in the IP core library and combined in unique ways by IMSAs to solve MOOPs. The accessibility of IP core elements allows the system to autonomously coordinate reconfigurable behaviors to solve new problems in novel ways.

In the case of microprocessors, the IMSAs activate specific functions by creating short-cuts for routine tasks. The IMSAs narrow the constraints between a set of options in the microprocessor programming in order to accelerate its behaviors. While limiting the range of applications, this method allows the MPs to work with multiple FPGAs to create self-organizing processes.

In an additional embodiment of the present system, the IP cores are self-programming. After identifying application objectives, the IMSAs access the IP core library and select the most appropriate IP core from the library to solve similar problems. The closest IP core(s) are then tuned to specific application problems.

Multiple IP cores are used to control multiple EHW nodes in an iSoC simultaneously (or sequentially). Complex functions are performed by multiple asynchronous nodes. Interoperations are controlled by IP cores that are combined and recombined into an efficient processing network. By combining sequential or parallel IP cores, the present system continuously reprograms multiple FPGAs. In particular, sequential IP core use produces indeterministic behaviors for FPGAs for multi-functionality within specific contingency thresholds.

(8) Plasticity Using Reconfigurable 3D SoC for Polymorphous Computing

IP cores provide programming specifications for complex programmable logic devices such as FPGAs. IP cores are integrated into FPGAs in the present system by using IMSAs and metaheuristics that identify the specific IP core elements to be combined in unique ways for solving specific MOOPs. The IP cores activate a change of geometrical configuration of the reconfigurable intra-layer 3D IC node logic blocks in the iSoC in order to optimize their problem solving operations. As the environment changes, the constraints change that require a reprogramming of the hardware circuits.

The internal network features of the present system provide parameters for the interaction of multiple interactive reprogrammable embedded computing components. By self-organizing multiple hardware components, i.e., by reconfiguring their application specificity in real time, the system adapts to evolving environment conditions.

The iSoC employs several parallel processes to assess the changing environment, the present capabilities of the network fabric, and the reconfigurable components of the system. The iSoC models various scenarios by using stochastic processes and analysis of past behaviors in order to develop scenario solution options to solve MOOPs. IMSAs perform the modeling processes by using adaptive modeling algorithms.

The combination of these processes presents a novel adaptive computing environment that employs polymorphous computing architectures and processes to accomplish evolutionary objectives.

(9) Environmental Interaction with Reprogrammable SoC

The 3D iSoC presents a model for a cognitive control system. The system produces co-evolution of software and hardware components in an integrated reconfigurable network fabric. This polymorphous network architecture is more reliable and far faster than previous systems.

The iSoC is auto programming. The system is structured with elastic dynamics for both exogenous adaptation and endogenous transformation. Specifically, part of the chip may be used to engage in programming itself while it simultaneously solves a range of problems. This is performed by implementing D-EDA tools on board the chip to produce IP cores and install them with IMSAs.

The evolving environment provides specific feedback for the iSoC according to which it must reorganize in order to perform application tasks. This environmental interaction with the reprogrammable iSoC produces adaptation of the reprogrammable network components.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.) the terms (including a reference to a “means”) used to describe such elements are intended to correspond, unless otherwise indicated, to any element that performs the specified function of the described element (i.e., that is functionally equivalent), even though not structurally equivalent to the disclosed structure that performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

### Acronyms

3D, three dimensional
ACO, ant colony optimization
AIS, artificial immune system
ASIC, application specific integrated circuit
BOOP, bi-objective optimization problem
CMOS, complementary metal oxide semiconductor
CPLD, complex programmable logic device
D-EDA, dynamic electronic design automation
DIVA, data intensive architecture
DLP, data level parallelism
EDA, electronic design automation
EHW, evolvable hardware
eMOOP, evolvable multi-objective optimization problem
Flops, floating operations per second
FPCA, field programmable compute array
FPGA, field programmable gate array
GALA, globally asynchronous locally asynchronous
HPPS, high performance processing system
ILP, instruction level parallelism
IMSA, intelligent mobile software agent
IP, intellectual property
iSoC, intelligent system on a chip
MAS, multi-agent system
MEMS, micro electro mechanical system
MONARCH, morphable networked micro-architecture
MOOP, multi-objective optimization problem
MPSOC, multi-processor system on a chip
NEMS, nano electro mechanical system
NoC, network on a chip
PCA, polymorphous computing architecture
PIM, processor in memory
PSO, particle swarm optimization
RISC, reduced instruction set computing
SCOC, supercomputer on a chip
SDS, stochastic diffusion search
SoC, system on a chip
SOI, silicon on insulation
SOPC, system on a programmable chip
SPE, synergistic processor element
TLP, thread level parallelism
TRIPS, Tera-op reliable intelligently adaptive processing system
TSV, through silicon via
ULSI, ultra large scale integration
VLSI, very large scale integration
WSPS, wafer level processed stack packages

### DESCRIPTION OF THE DRAWINGS

FIG. 1 is a schematic drawing showing a 3D SoC with multiple configuration options of neighborhood cluster(s).

FIG. 2 is a schematic drawing showing different sets of node composition of neighborhood clusters in a 3D SoC.

FIG. 3 is a schematic diagram showing a configuration of eight sets of neighborhood clusters in a 3D SoC.

FIG. 4 is a schematic diagram showing a configuration of eight sets of neighborhood clusters in a 3D SoC.

FIG. 5 is a flow chart showing the reconfiguration of a neighborhood cluster in a 3D SoC.

FIG. 6 is a schematic diagram showing the process of restructuring node configurations in a iSoC neighborhood cluster.

FIG. 7 is a schematic diagram showing the activation by a central node of neighborhood clusters in a 3D SoC.

FIG. 8 is a schematic diagram illustrating a central 3D node in which layers 4 and 7 are used to interact with nodes in neighborhood clusters in the 3D SoC.

FIG. 9 is a schematic diagram showing a single layer FPGA of a multilayer IC with transforming logic arrays in which specific groups of transformable logic arrays control specific nodes in a 3D SoC.

FIG. 10 is a schematic diagram showing a 3D SoC in which the reconfigurable central node controls neighborhood cluster data and instruction flows and in which the neighborhoods transform their configuration and send outputs to the central node.

FIG. 11 is a schematic diagram showing a partial view of the 3D SoC transformation of neighborhood clusters in which the central node is interacting with and directing the neighborhood cluster configurations and receiving feedback from clusters.

FIG. 12 is a schematic diagram showing the flow of data and interactions between transforming neighborhood clusters.

FIG. 13 is a flow chart showing the use of reconfigurable nodes to solve MOOPs.

FIG. 14 is a flow chart showing the routing process of the central node in a 3D SoC.

FIG. 15 is a schematic diagram showing a 3D SoC with eight neighborhood clusters and a central node with asynchronous clocking.

FIG. 16 is a flow chart showing the organization process of 3D SoC neighborhoods with variable clocks.

FIG. 17 is a schematic diagram showing the interaction process between nodes in each neighborhood cluster of a 3D SoC and the course-grained task allocation from the central node to neighborhoods.

FIG. 18 is a flow chart showing the allocation of MOOPs and BOOPs to generate solutions in neighborhood clusters of a 3D SoC.

FIG. 19 is a task graph illustrating parallel and sequential MOOPs across multiple configurations of nodes in neighborhood clusters of a 3D SoC.

FIG. 20 is a flow chart describing the use of task graphs to reconfigure neighborhood clusters in a 3D SoC.

FIG. 21 is a schematic diagram showing the interactions between layers of two multilayer IC nodes in a 3D SoC.

FIG. 22 is a schematic diagram showing the external stimulus and feedback activating cluster transformations illustrating the spiking traffic behaviors of clusters A and H.

FIG. 23 is a chart showing hardware system layers in a 3D SoC.

FIG. 24 is a chart showing the levels of software processes used in a 3D SoC.

FIG. 25 is a schematic diagram showing the use of IMSAs in a neighborhood cluster of a 3D SoC.

FIG. 26 is a schematic diagram showing the use of a MAS connecting layers in a multilayer IC using IMSAs.

FIG. 27 is a schematic diagram showing the interaction of IMSAs between layers of 3D multilayer IC nodes in a 3D SoC.

FIG. 28 is a schematic diagram showing the use of competitive IMSAs between two 3D nodes in which the IMSAs use auction incentives to negotiate an outcome.

FIG. 29 is a schematic diagram showing the three way feedback process between an FPGA, the modeling process and an indeterministic environment by using IMSAs.

FIG. 30 is a schematic diagram showing the use of a compiler to intermediate between higher and lower level programming with an MAS.

FIG. 31 is a schematic diagram showing the use of compilers in the central node of a 3D SoC and key nodes in neighborhood clusters to pass IMSAs to minor nodes.

FIG. 32 is a flow chart showing the use of a compiler in a 3D SoC node to organize processes to solve MOOPs.

FIG. 33 is a schematic diagram showing the use of sensors to interact between nodes in multiple multilayer ICs.

FIG. 34 is a flow chart showing the use of collectives of IMSAs in a 3D SoC to solve MOOPs.

FIG. 35 is a schematic diagram showing the use of multiple parallel operations to solve MOOPs between node layers in a specific sequence of activities.

FIG. 36 is a flow chart showing the application of metaheuristics to solve MOOPs in a SoC.

FIG. 37 is a flow chart showing the reconfiguration of EHW to solve MOOPs in a 3D SoC.

FIG. 38 is a flow chart showing the reconfiguration processes of multiple 3D SoC components.

FIG. 39 is a flow chart showing the modeling of multiple scenarios to solve MOOPs in a 3D SoC.

FIG. 40 is a flow chart showing the self-organizing processes of multiple IC layers in 3D nodes in a 3D SoC.

FIG. 41 is a schematic diagram showing the use of IP core elements combined for each of several adaptive FPGA layers of a multilayer IC as they interact with an evolving environment.

FIG. 42 is a schematic diagram showing the interaction of an iSoC center core with both internal network and an evolving environment.

FIG. 43 is a schematic diagram showing the process of applying modeling scenarios to solve eMOOPs in a SoC.

FIG. 44 is a schematic diagram showing the internal and external interaction dynamics of a 3D SoC as it interacts with an evolving environment.

FIG. 45 is a flow chart showing the use of EDA and IP cores to solve MOOPs in a 3D SoC.

### DETAILED DESCRIPTION OF THE DRAWINGS

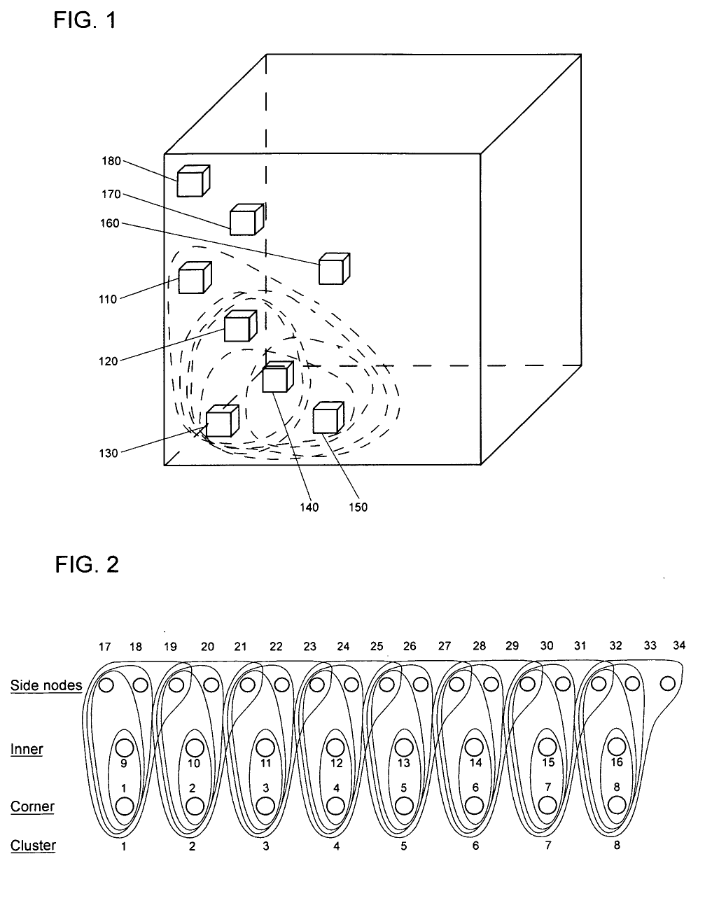

FIG. 1 shows a 3D SoC with multiple configuration options of neighborhood cluster(s). The configuration of the clusters changes from a set with two nodes (120 and 130) to a set with three nodes (120, 130 and 140) to a set with four nodes (120, 130, 140 and 150) to a set with five nodes (110, 120, 130, 140 and 150). The reconfiguration of the different sets of nodes allows the reaggregation of neighborhood clusters to modulate the changing demands of specific evolving applications.

FIG. 2 shows different sets of node composition of neighborhood clusters in a 3D SoC. The neighborhood cluster composition of 34 of the nodes in the 3D SoC continually reaggregates. Each cluster consists of a corner node and an inner node. The addition and subtraction of side nodes for specific computational requirements constitutes the reaggregation of the set of nodes. FIG. 2 describes the multiple options of the different combinatorial possibilities within the eight distinct neighborhood groups.

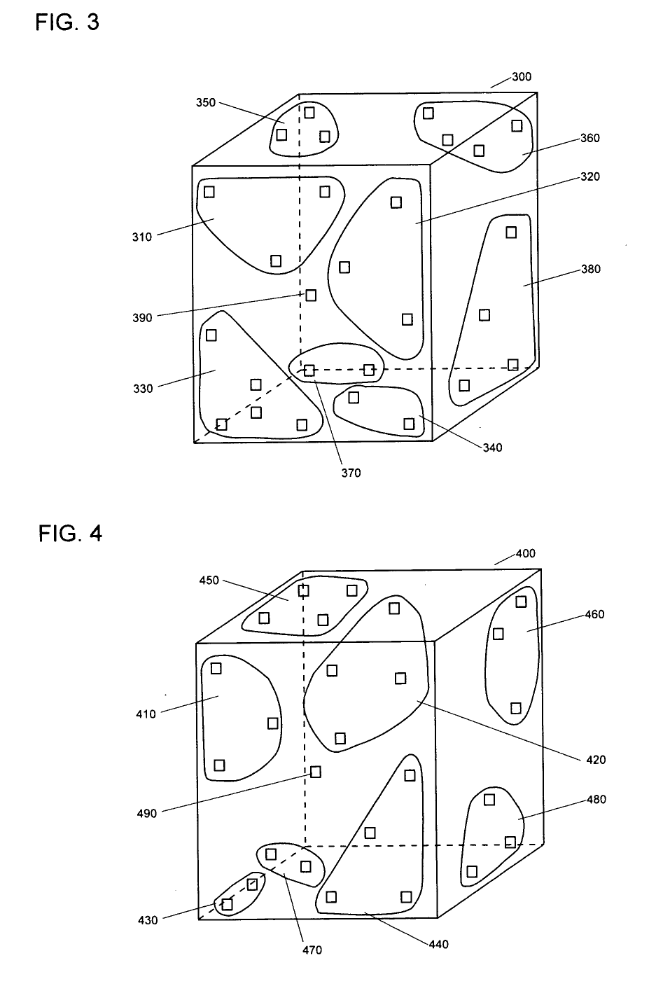

FIG. 3 and 4 show different configurations of the eight sets of neighborhood clusters in a 3D SoC. In FIG. 3, the clusters of nodes are configured into groups with prominent nodes shown (310, 320, 330, 340, 350, 360, 370, 380 and 390). In FIG. 4, the clusters of nodes are configured into groups with a different set of nodes shown in each neighborhood configuration.

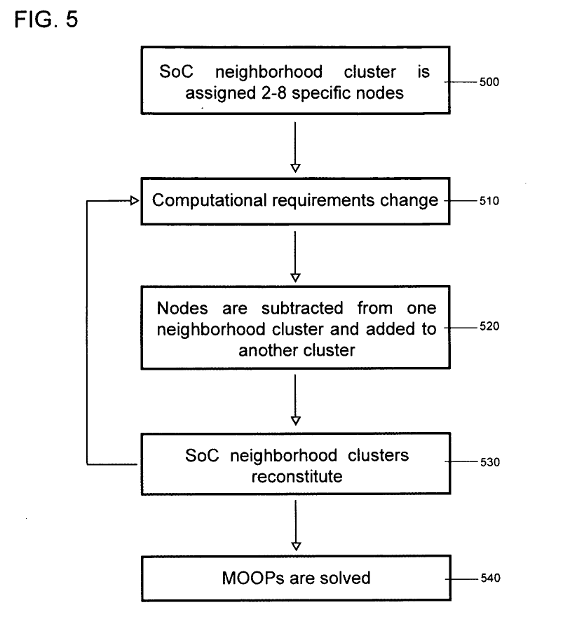

FIG. 5 is a flow chart showing the reconfiguration of a neighborhood cluster in a 3D SoC. After the SoC neighborhood cluster is assigned 2-8 specific nodes (500), the computational requirements change (510) and nodes are subtracted from one neighborhood cluster and added to another cluster (520). The SoC neighborhood clusters reconstitute into different sets of nodes (530) as the computational requirements continue to change until the MOOPs are solved (540).

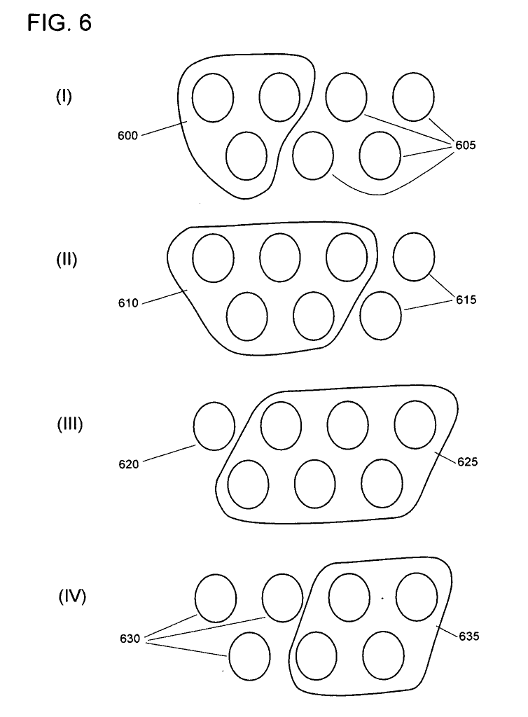

FIG. 6 shows the process of restructuring node configurations in an iSoC neighborhood cluster. In the first phase, three nodes (600) are coordinated to operate in the cluster. In the second phase, the cluster incorporates an additional two nodes (610). In the third phase, however, the configuration of the node set changes to include a different grouping of six nodes (625). In the final phase, the four nodes are shown (635) that comprise the reconfigured set of nodes in the cluster.

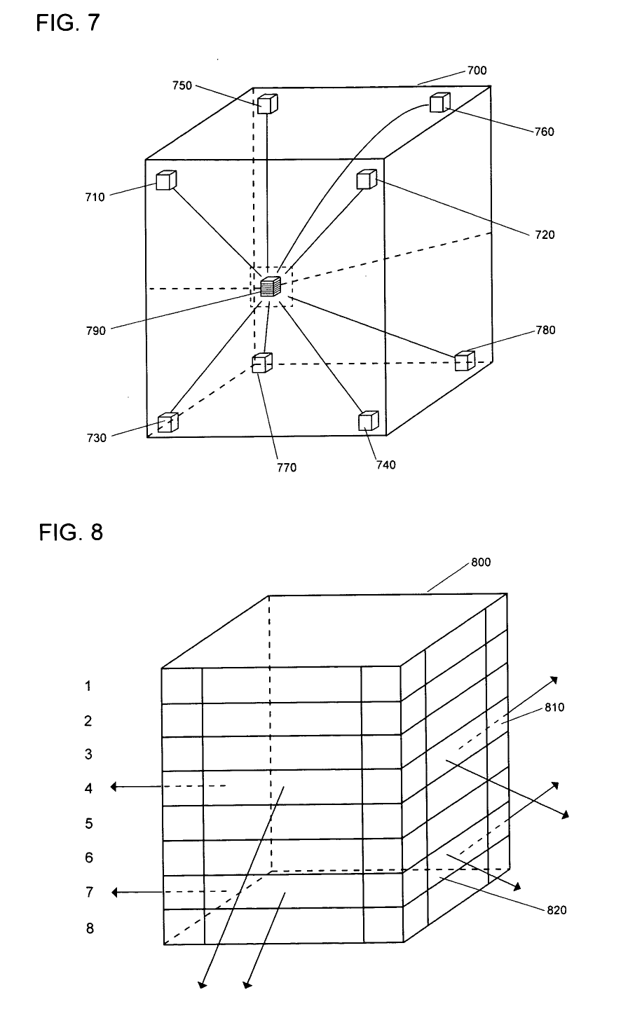

FIG. 7 shows the activation by a central node of neighborhood clusters in a 3D SoC. The central node (790) acts as a controller to manage the operations of the various neighborhood clusters, which are administered by the corner nodes. The multiple layers of the central node may dedicate a separate layer to manage each specific cluster.

FIG. 8 shows a central 3D node in which layers 4 and 7 are used to interact with nodes in neighborhood clusters in the 3D SoC. In this instance, layers 4 (810) and 7 (820) behave as the import and export components for the forwarding and retrieval of data and instructions between other nodes.

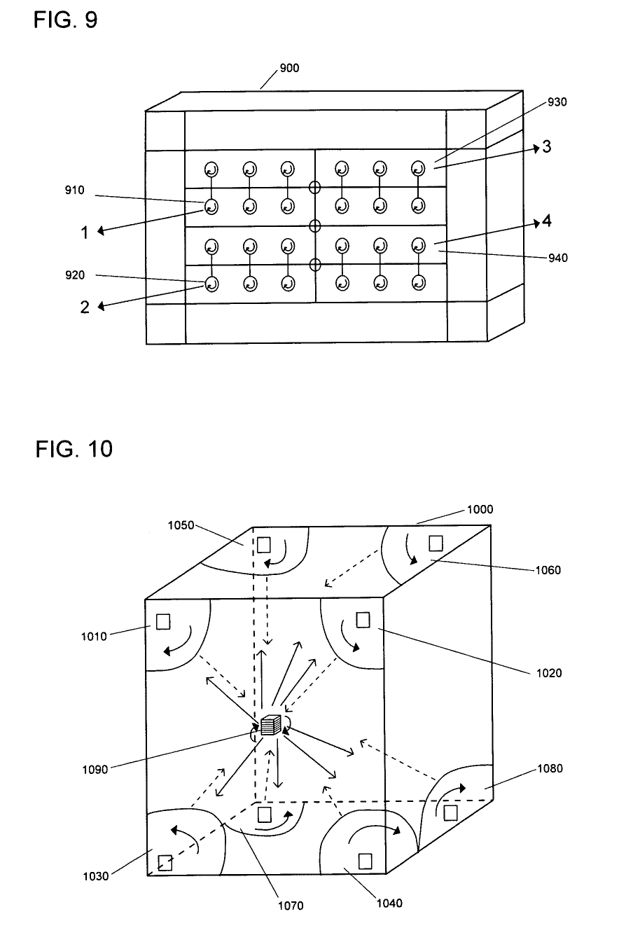

FIG. 9 shows a single layer FPGA of a multilayer IC with transforming logic arrays in which specific groups of transformable logic arrays control specific nodes in a 3D SoC. The logic arrays 1 (910), 2 (920), 3 (930) and 4 (940) each control a different set of components and devices in the SoC.

FIG. 10 shows a 3D SoC (1000) in which the reconfigurable central node controls neighborhood cluster data and instruction flows and in which the neighborhoods transform their configuration and send outputs to the central node. The solid arrows emanating from the central node (1090) signify the instructions sent to the separate neighborhood clusters. The clusters (1010, 1020, 1030, 1040, 1050, 1060, 1070 and 1080) then proceed to reconfigure their hardware structures according to specific task goals so as to solve MOOPs. The results of their computational analyses are signified by the dotted lines that indicate data forwarded to the central node. In this drawing, the central node is constantly reconfiguring in order to efficiently satisfy its computational goals.

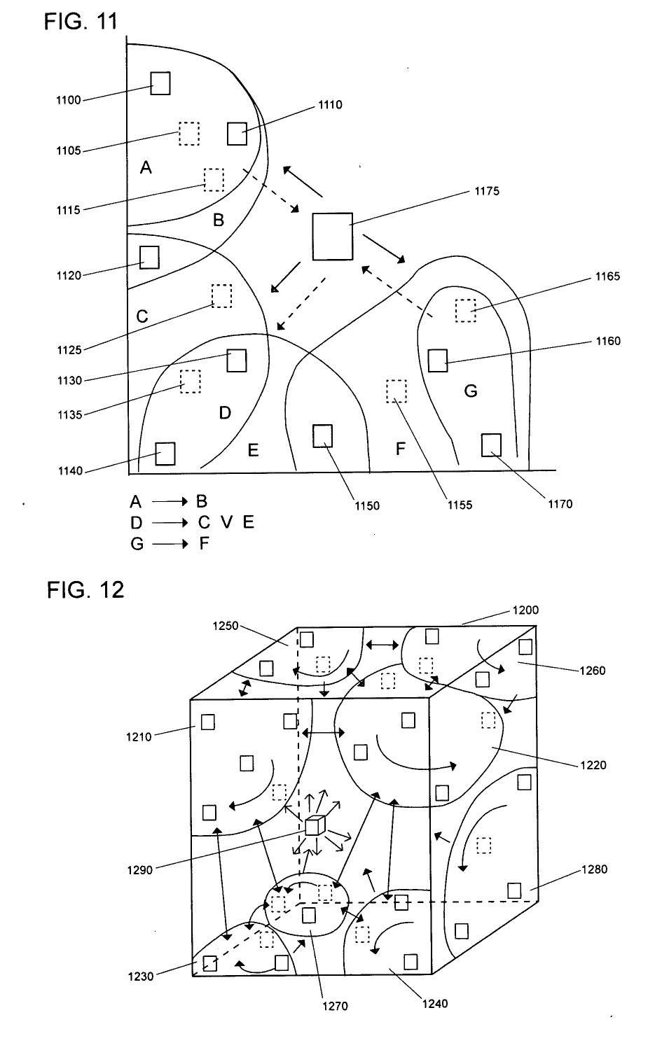

FIG. 11 shows a partial view of the 3D SoC transformation of neighborhood clusters in which the central node is interacting with and directing the neighborhood cluster configurations and receiving feedback from clusters. The cluster configurations in the neighborhood clusters constantly reorganize as they are directed by the central node. The set of nodes include A (1100, 1105, 1110 and 1115), B (1100, 1105, 1110, 1115 and 1120), C (1120, 1125, 1130, 1135 and 1140), D (1130, 1135 and 1140), E (1130, 1135, 1140 and 1150), F (1150, 1155, 1160, 1165 and 1170) and G (1160, 1165 and 1170). The set of A restructures to B, D is the subset that consists of the overlap of C and E and G restructures to F.

FIG. 12 shows the flow of data and interactions between transforming neighborhood clusters. As the data flows within each neighborhood cluster and between adjacent neighborhoods, the central node of the 3D iSoC directs traffic flows.

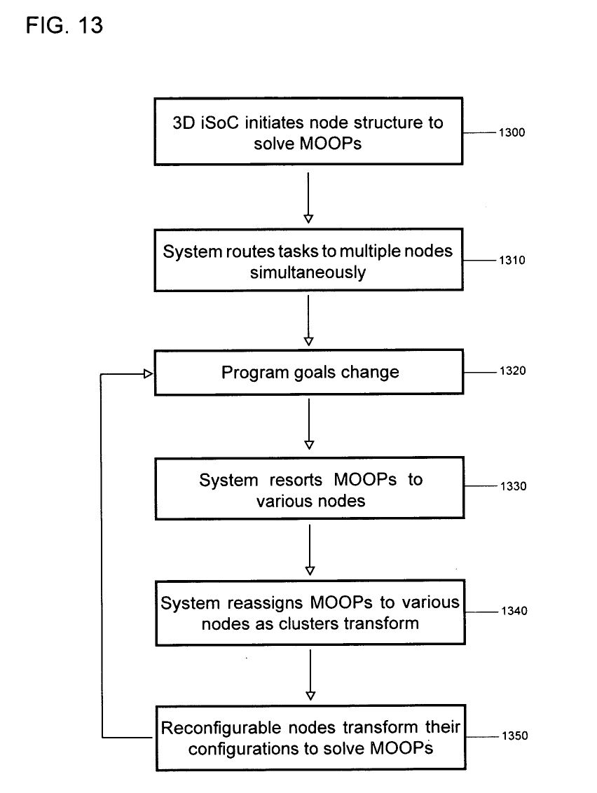

FIG. 13 is a flow chart showing the use of reconfigurable nodes to solve MOOPs. After the 3D iSoC initiates node structure to solve MOOPs (1300), the system routes tasks to multiple nodes simultaneously (1301). As program goals change (1320), the system resorts MOOPs to various nodes (1330) and the system reassigns MOOPs to various nodes as the cluster transforms (1340). The reconfigurable nodes transform their configurations to solve MOOPs (1350) and repeat the process as goals continue to change.

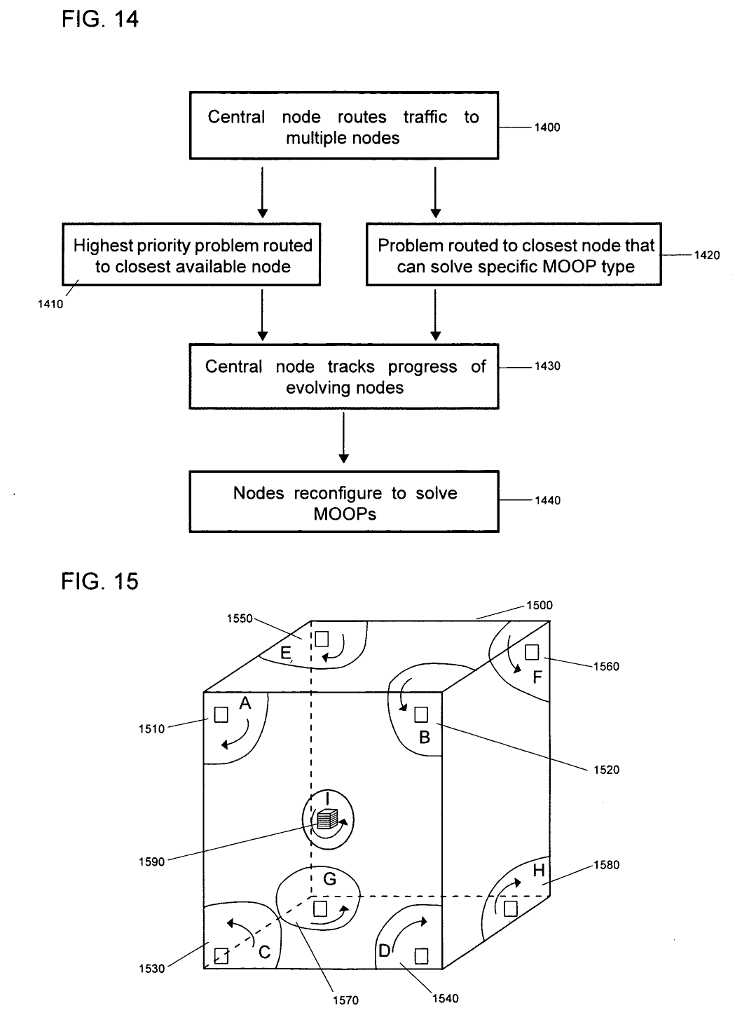

FIG. 14 shows the routing process of the central node in a 3D SoC. The central node routes traffic (1400) with the highest priority problem routed to the closest available node (1410) or the closest node that can solve a specific MOOP type (1420). In either case, the central node tracks progress of the evolving nodes (1430) and the nodes reconfigure to solve MOOPs (1440).

FIG. 15 shows a 3D SoC with eight neighborhood clusters and a central node with asynchronous clocking. Each of the neighborhood clusters (A-H) and the central node have different clocking.

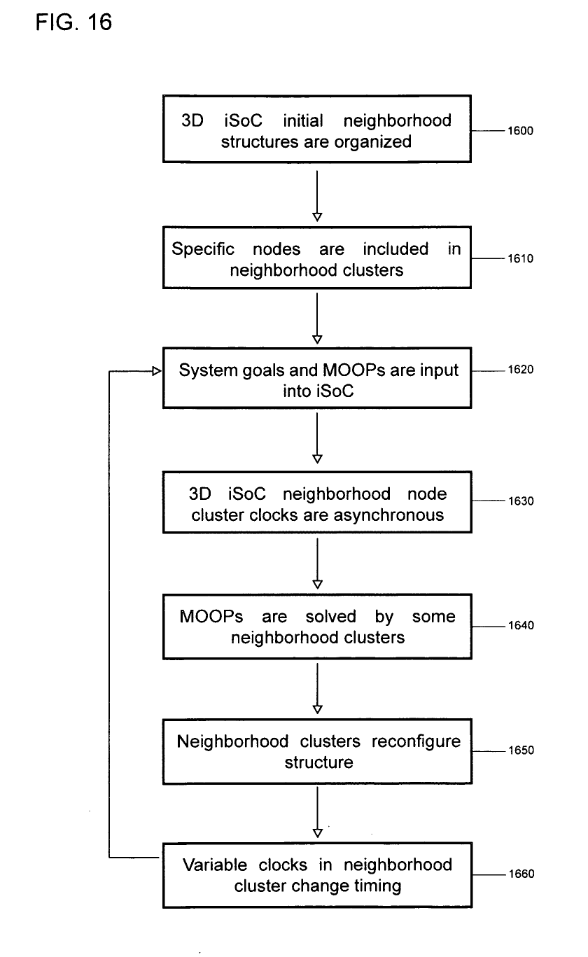

FIG. 16 is a flow chart showing the organization process of 3D SoC neighborhoods with variable clocks. After the 3D iSoC initial neighborhood structures are organized (1600), the specific nodes are included in neighborhood clusters (1610) and system goals and MOOPs are input into the iSoC (1620). The 3D iSoC neighborhood node cluster clocks are asynchronous (1630) and MOOPs are solved by some neighborhood clusters (1640), which reconfigure their structure (1650). The variable clocks in neighborhood cluster change timing (1660) and the system repeats as new goals and MOOPs are input.

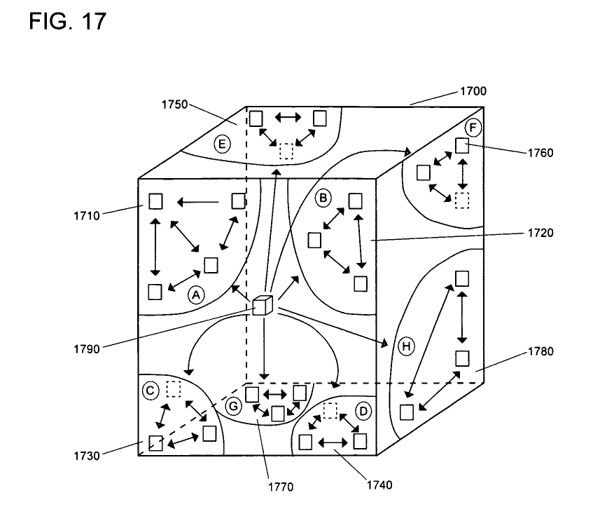

FIG. 17 shows the interaction process between nodes in each neighborhood cluster of a 3D SoC and the course-grained task allocation from the central node to neighborhoods. The nodes within the neighborhood clusters (A-H) are shown interacting. The central node is shown providing controlling programming code for assigning tasks to the neighborhoods.

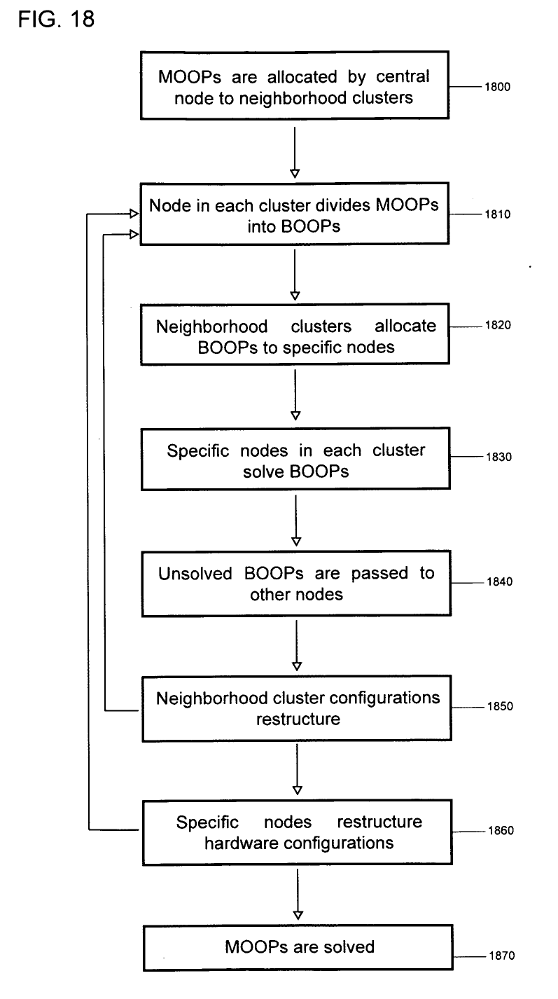

FIG. 18 is a flow chart showing the allocation of MOOPs and BOOPs to generate solutions in neighborhood clusters of a 3D SoC. MOOPs are allocated by the central node to neighborhood clusters (1800). A node in each cluster divides the MOOPs into BOOPs (1810) and the clusters allocate BOOPs to specific nodes (1820). Specific nodes in each cluster solve BOOPs (1830), while unsolved BOOPs are passed to other nodes (1840) with different capabilities. The neighborhood cluster configurations restructure (1850) to solve the BOOPS and the nodes restructure their hardware configurations (1860). The system processes more MOOPs until the MOOPs are solved (1870).

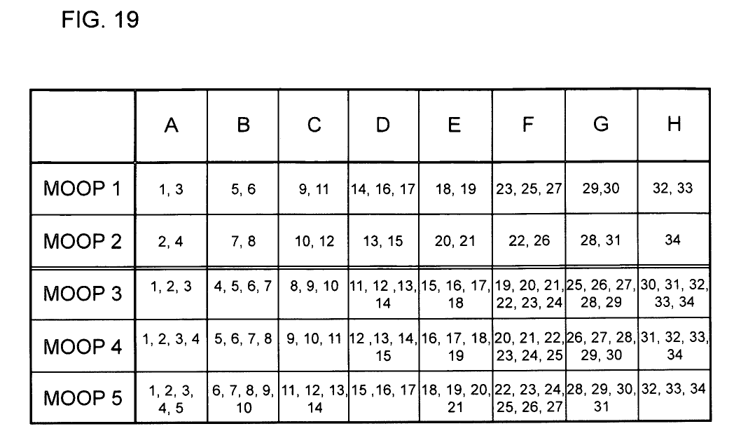

FIG. 19 shows parallel and sequential MOOPs across multiple configurations of nodes in neighborhood clusters of a 3D SoC. The set of 34 neighborhood nodes divide MOOPs across the eight neighborhoods. In the first two MOOPs, the eight neighborhood clusters (A-H) divide the MOOPs across different nodes. MOOP 1 is divided across nodes 1, 3, 5, 6, 9, 11, 14, 16, 17, 18, 19, 23, 25, 27 29, 30 32 and 33 in the 8 clusters, while MOOP 2 is divided across nodes 2, 4, 7, 8, 10, 12, 13, 15, 20, 21, 22, 26, 28, 31 and 34 in these same clusters. MOOPs 3, 4 and 5, are divided across the 34 nodes individually. However, these three MOOPs are distributed across different sets of nodes as indicated in the table.

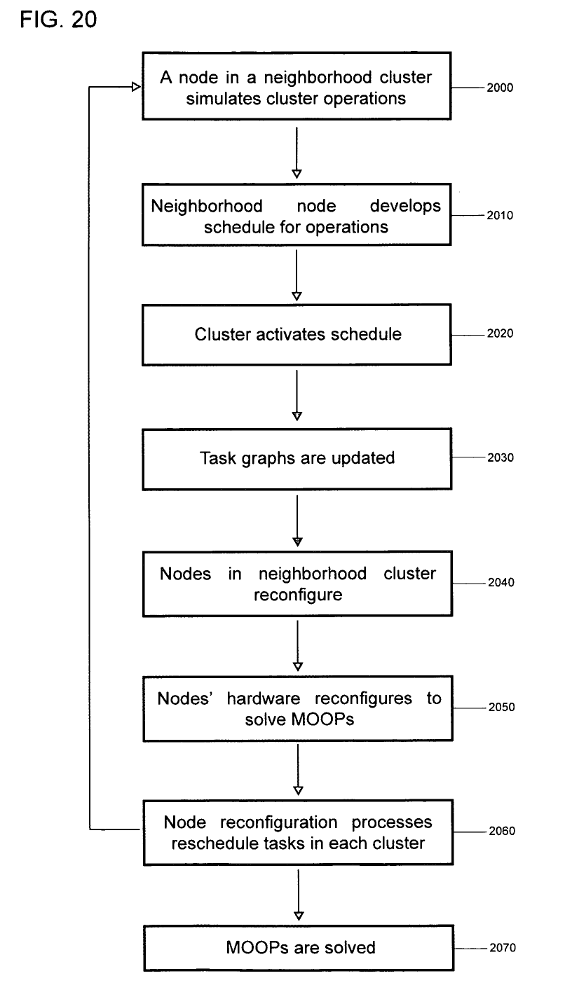

FIG. 20 is a flow chart showing the use of task graphs to reconfigure neighborhood clusters in a 3D SoC. After a node in a neighborhood cluster simulates cluster operations (2000), it develops a schedule for operations (2010). The cluster activates the schedule (2020) and task graphs are updated (2030). The nodes in the neighborhood cluster reconfigure (2040) and the nodes' hardware configures to solve MOOPs (2050). The node reconfiguration processes reschedule tasks in each cluster (2060) and the process repeats as neighborhood clusters are reconfigured until the MOOPs are solved (2070).

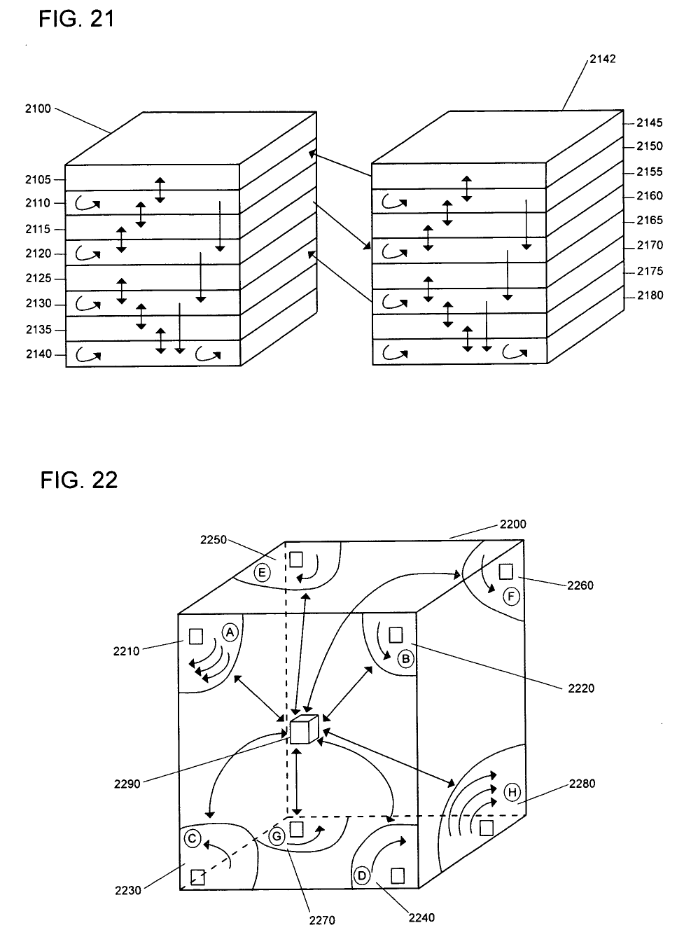

FIG. 21 shows the interactions between layers of two multilayer IC nodes in a 3D SoC. Each multilayer IC node (2100) transfers data and instructions between layers as the layers periodically transform their hardware configurations. The nodes exchange data and instructions periodically as indicated by the passing of data from layer one and six of the right node to layer two and six of the first node and from layer four of the left node to layer four of the right node.

FIG. 22 shows the external stimulus and feedback activating cluster transformations illustrating the spiking traffic behaviors of clusters A and H.

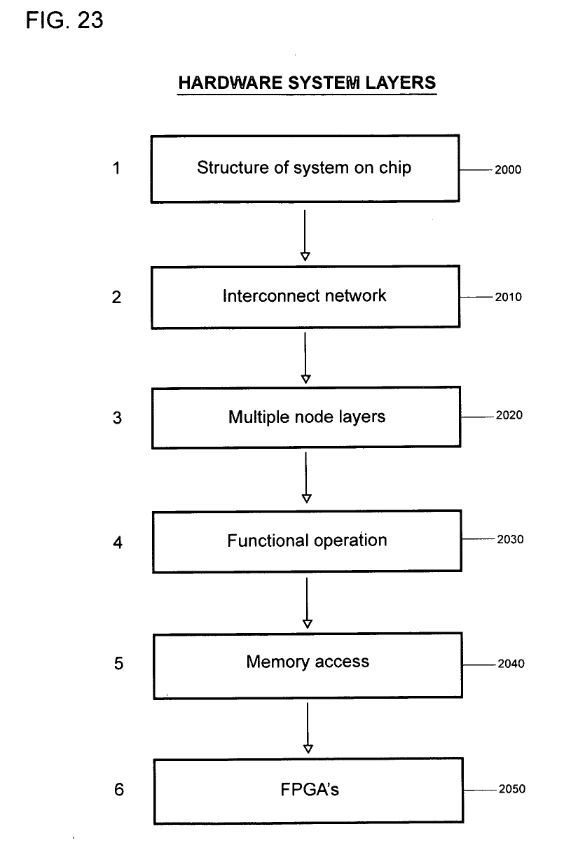

FIG. 23 shows hardware system layers in a 3D SoC. Layer one is the structure of the system on chip (SoC) (2000). Layer two is the interconnect network (2010). Layer three is multiple node layers (2020). Layer four is functional operation of the SoC (2030). Layer five is memory access (2040) and layer six is FPGAs (2050).

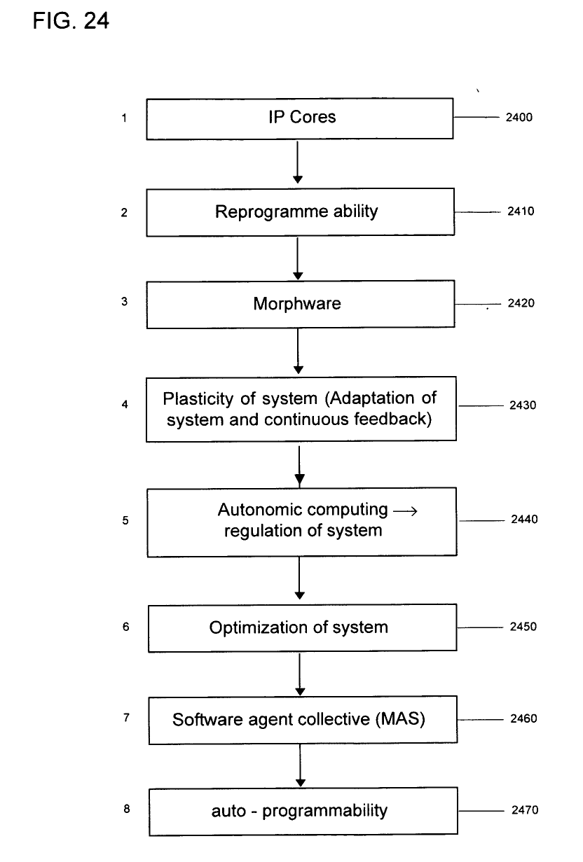

FIG. 24 is a chart showing the levels of software processes used in a 3D SoC. IP cores (2400) are at layer one. Layer two consists of reprogrammability (2410) and layer three consists of morphware (2420). Layer four consists of system plasticity (for the adaptation of the system and continuous feedback) (2430). Layer five consists of autonomic computing for auto-regulation of the system (2440). Layer six is for optimization of the system (2450). Layer seven is for the multi-agent system comprised of IMSAs (2460) and layer eight is for auto-programmability (2470).

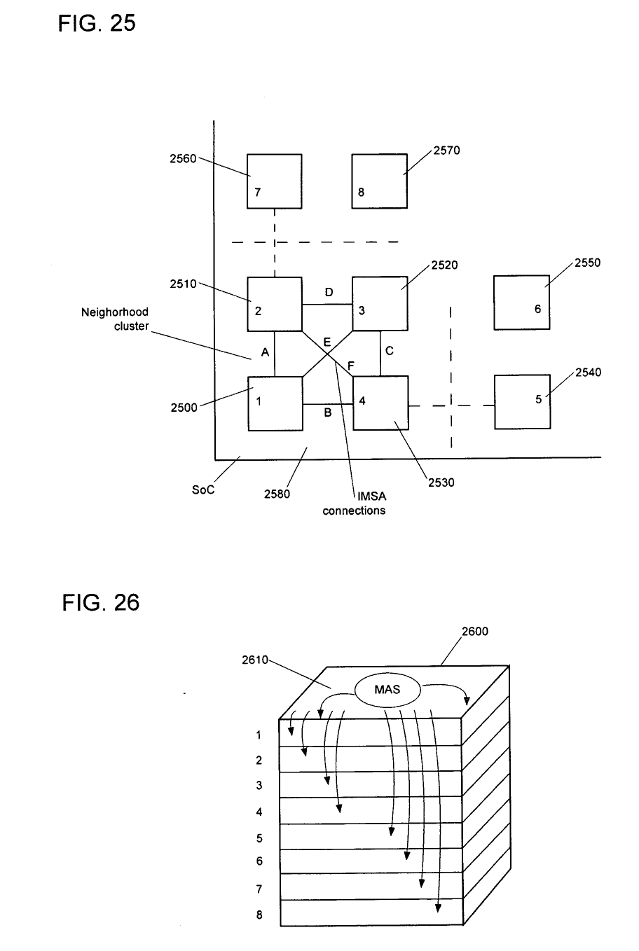

FIG. 25 shows the use of IMSAs in a neighborhood cluster of a 3D SoC. In the drawing, IMSAs operate in a sequence within the cluster of nodes 1, 2, 3 and 4. The IMSAs move from node 2 to 1 to 4 to 3 to 2 to 4 and back to 2.

FIG. 26 shows the use of a MAS connecting layers in a multilayer IC using IMSAs. The IMSAs interact with all layers of a multilayer IC and allow the interaction of the layers.

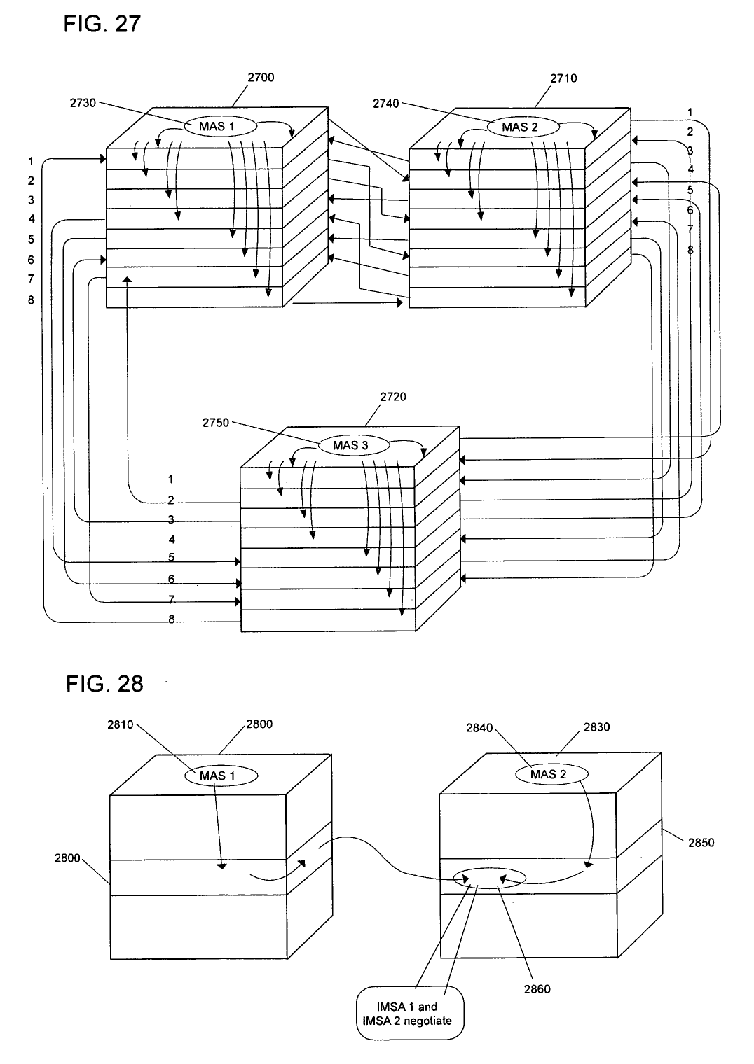

FIG. 27 shows the interaction of IMSAs between layers of 3D multilayer IC nodes in a 3D SoC. In this example, IMSAs from the MAS 1 (2730) at node 1 (2700) interact with IMSAs from MAS 2 (2740) in node 2 (2710) and MAS 3 (2750) in node 3 (2720). The IMSAs from the multiple nodes are then redistributed to different layers within each node.

FIG. 28 shows the use of competitive IMSAs between two 3D nodes in which the IMSAs use auction incentives to negotiate an outcome. The IMSAs from MAS 1 (2810) in node 1 (2800) move to a layer of node 2 (2830) in order to negotiate with IMSAs from MAS 2 (2840). The area at 2860 indicates the negotiation process.

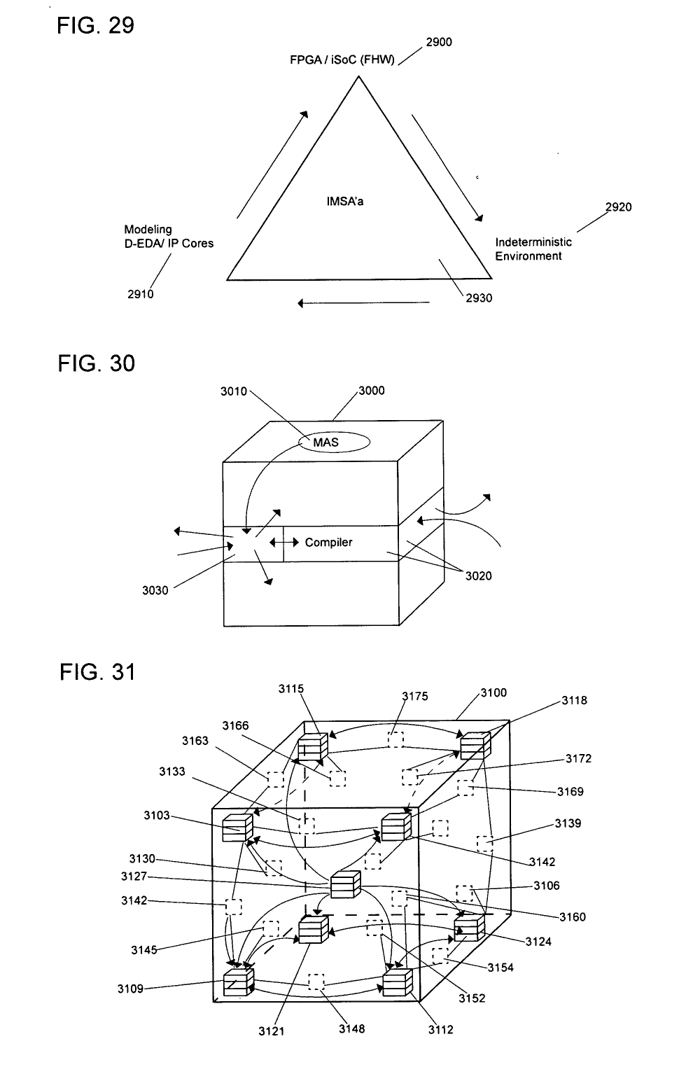

FIG. 29 shows the three way feedback process between an FPGA, the modeling process and an indeterministic environment by using IMSAs. The environment provides feedback to IP cores, which reprogram the FPGAs, which in turn interact with the environment. IMSAs perform the interactions between these elements.

FIG. 30 shows the use of a compiler to intermediate between higher and lower level programming with an MAS. The compiler is illustrated on one layer of the multilayer IC as it interacts with other layers on the IC. The layer with the compiler also receives data streams from and sends data streams to other nodes in the 3D iSoC.

FIG. 31 shows the use of compilers in the central node of a 3D SoC and key nodes in neighborhood clusters to pass IMSAs to minor nodes. The corner nodes in the SoC interact with minor neighborhood nodes. The central node interacts with the corner nodes.

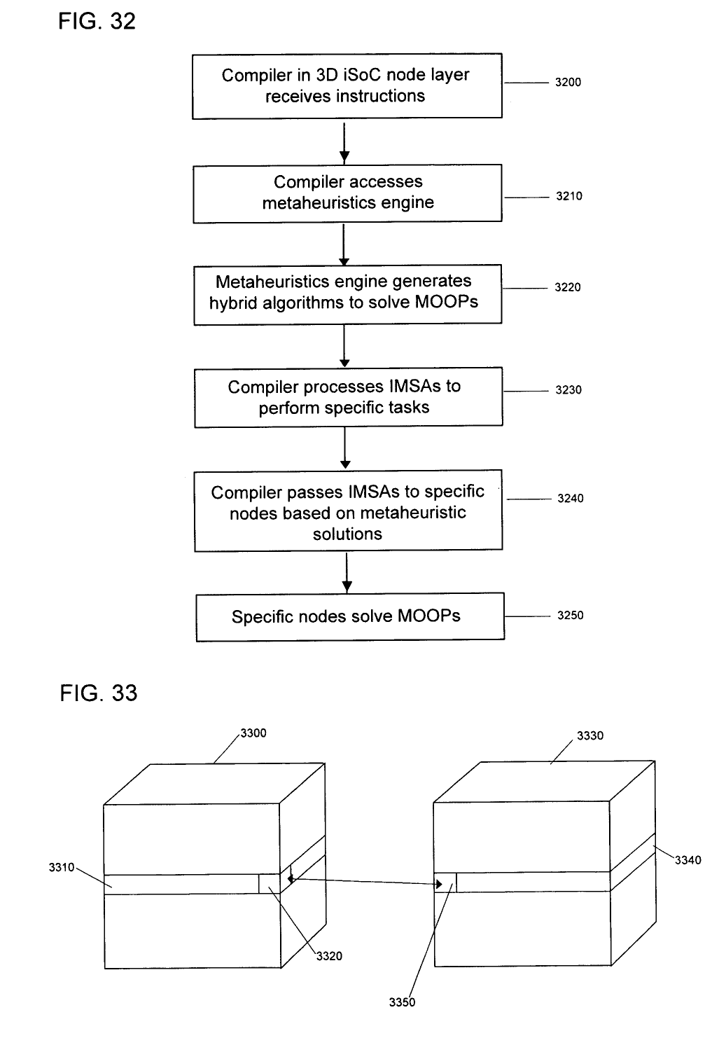

FIG. 32 is a flow chart showing the use of a compiler in a 3D SoC node to organize processes to solve problems. The compiler in a 3D iSoC node layer receives instructions (3200) and accesses metaheuristics engine (3210). The metaheuristics engine generates hybrid algorithms to solve MOOPs (3220) and the compiler processes IMSAs to perform specific tasks (3230). The compiler passes IMSAs to specific nodes based on metaheuristic solutions (3240) and specific nodes solve MOOPs (3250).

FIG. 33 shows the use of sensors to interact between nodes in multiple multilayer ICs. The sensors (3320 and 3350) are shown in the corners of layers of two nodes.

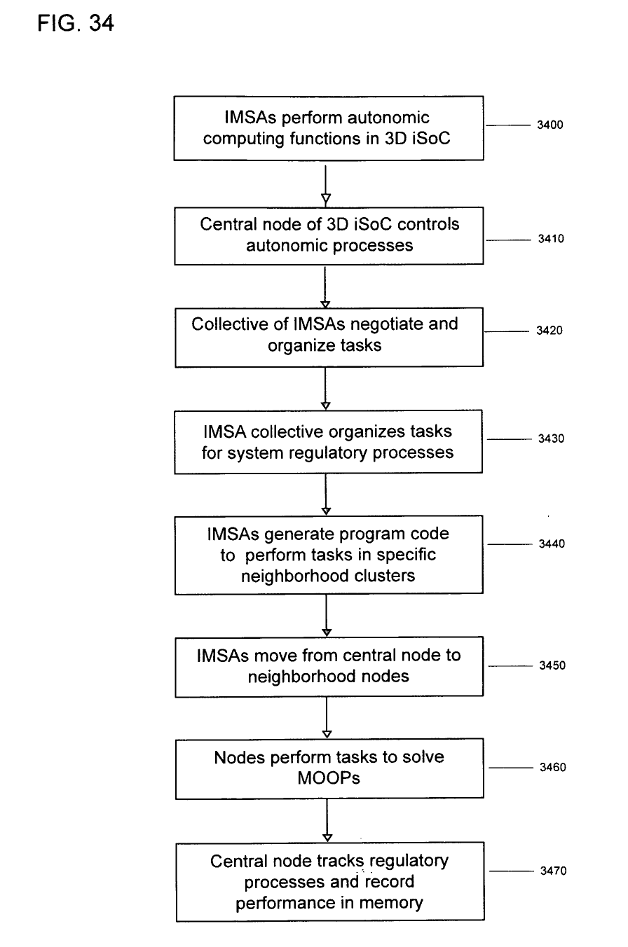

FIG. 34 is a flow chart showing the use of collectives of IMSAs in a 3D SoC to solve MOOPs. IMSAs perform autonomic computing functions in a 3D iSoC (3400) and the central node of the iSoC controls autonomic processes (3410). The collective of IMSAs negotiate and organize tasks (3420), including for system regulatory processes (3430). The IMSAs generate program code to perform tasks in specific neighborhood clusters (3440) and move from the central node to neighborhood nodes (3450). The nodes perform tasks to solve MOOPs (3460) and the central node tracks regulatory processes and record performance in memory (3470).

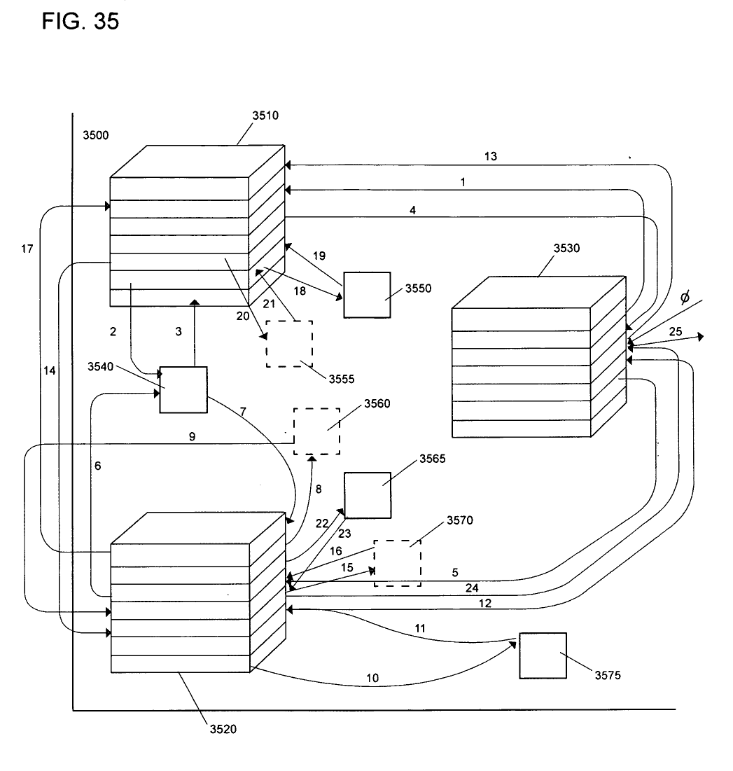

FIG. 35 shows the use of multiple parallel operations to solve MOOPs between node layers in a specific sequence of activities. An IMSA delivers a packet of data at layer four of the right multilayer node (3530). Layer two then passes data to layer 3 of the upper left multilayer node (3510). Layer 6 of this node then sends data to a minor node (3540), which sends data back to layer 7 of 3510. Layer 4 of node 3510 then sends data to layer 3 of 3530. Layer 6 of 3530 sends data to layer 4 of 3520. Layer 3 of 3520 sends data to the minor node at 3540, which sends data to the first layer of 3540. Layer 2 of 3540 sends data to the minor node 3560, which sends data to the fourth layer of 3520. This process continues according to the consecutive numbering of the data flows in the drawing.

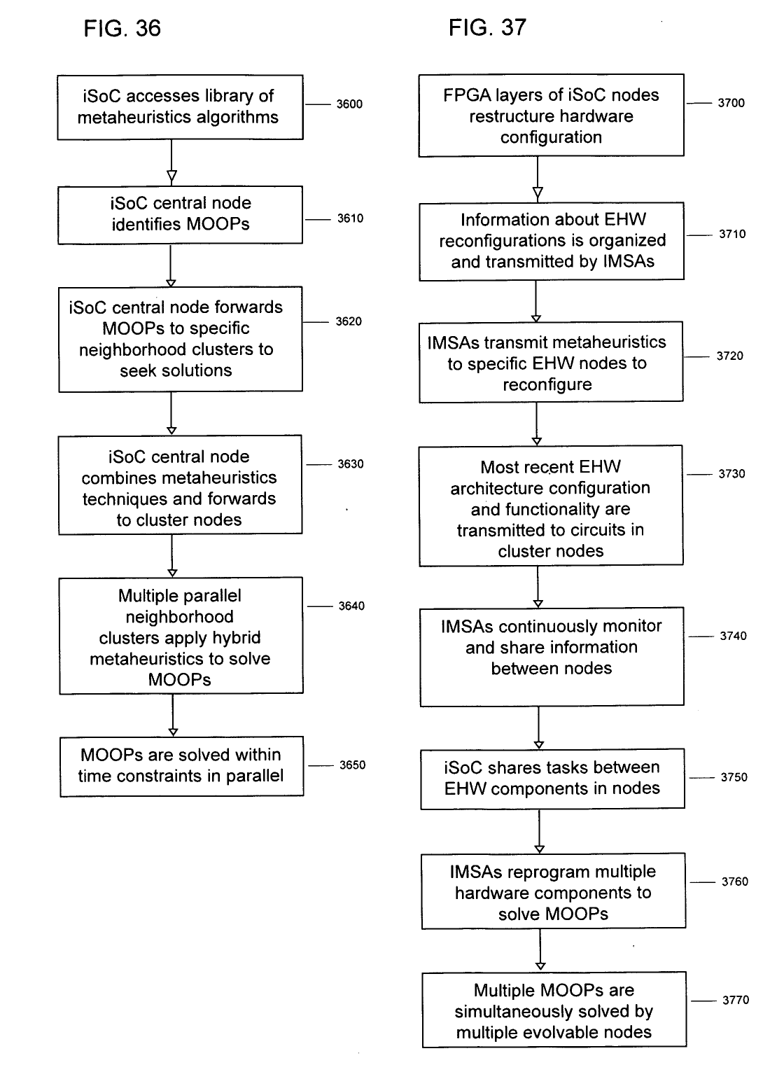

FIG. 36 is a flow chart showing the application of metaheuristics to solve MOOPs in a SoC. After the iSoC accesses a library of metaheuristics algorithms (3600), the central node identifies MOOPs (3610) and forwards MOOPs to specific neighborhood clusters to seek solutions (3620). The iSoC central node combines metaheuristics techniques and forwards them to cluster nodes (3630). The multiple parallel neighborhood clusters apply hybrid metaheuristics to solve MOOPs (3640), which are solved within time constraints (3650).

FIG. 37 is a flow chart showing the reconfiguration of EHW to solve MOOPs in a 3D SoC. The FPGA layers of iSoC nodes restructure hardware configuration (3700) and information about EHW reconfigurations is organized and transmitted by IMSAs (3710). The IMSAs transmit metaheuristics to specific EHW nodes to reconfigure (3720) and the most recent EHW architecture configuration and functionality are transmitted to circuits in cluster nodes (3730). The IMSAs continuously monitor and share information between nodes (3740) and the iSoC share tasks between EHW components in nodes (3750). The IMSAs reprogram multiple hardware components to solve MOOPs (3760) and multiple MOOPs are simultaneously solved by multiple evolving nodes (3770).

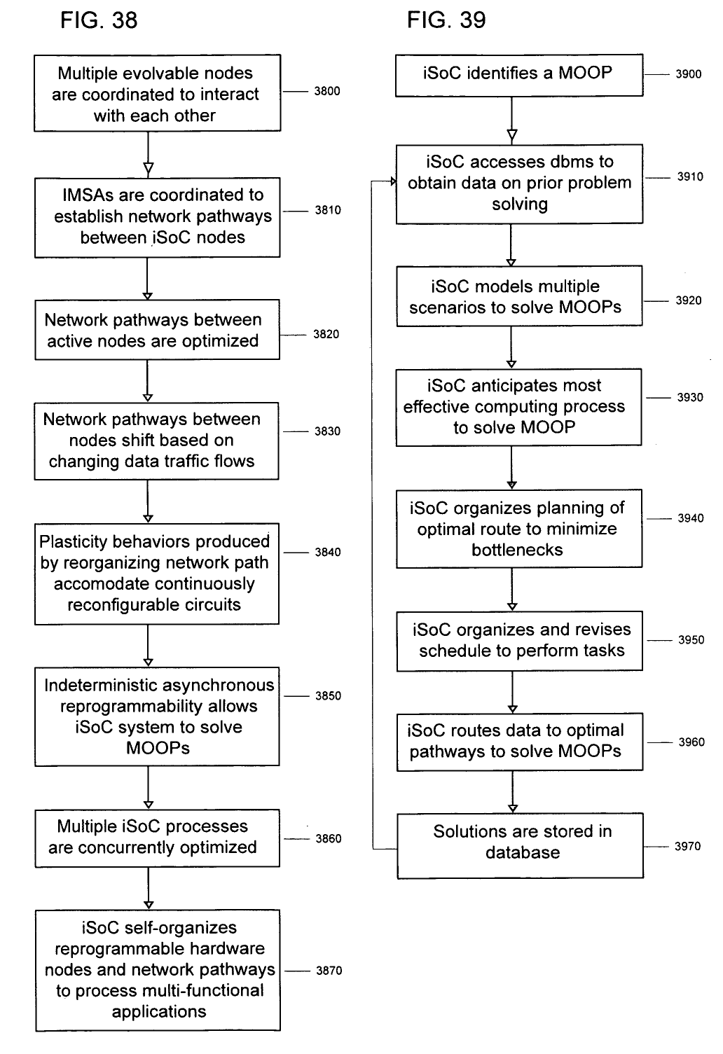

FIG. 38 is a flow chart showing the reconfiguration processes of multiple 3D SoC components. The multiple evolvable nodes are coordinated to interact with each other (3800) and IMSAs are coordinated to establish network pathways between iSoC nodes (3810). The network pathways between active nodes are optimized (3820) and the pathways between nodes shift based on changing data traffic flows (3830). The plasticity behaviors produced by the reorganizing network path accommodate continuously reconfigurable circuits (3840). Indeterministic asynchronous reprogrammability allows the iSoC system to solve MOOPs (3850). The multiple iSoC processes are concurrently optimized (3860) and the iSoC self-organizes reprogrammable hardware nodes and network pathways to process multi-functional applications (3870).

FIG. 39 is a flow chart showing the modeling of multiple scenarios to solve MOOPs in a 3D SoC. Once the iSoC identifies a MOOP (3900), it accesses a dbms to obtain data on prior problem solving (3910). The iSoC models multiple scenarios to solve MOOPs (3920) and anticipates the most effective computing process to solve the MOOP (3930). The iSoC organizes planning of an optimal route to minimize bottlenecks (3940) and revises the schedule to perform tasks (3950). The iSoC routes data to optimal pathways to solve MOOPs (3960) and solutions are stored in the database (3970).

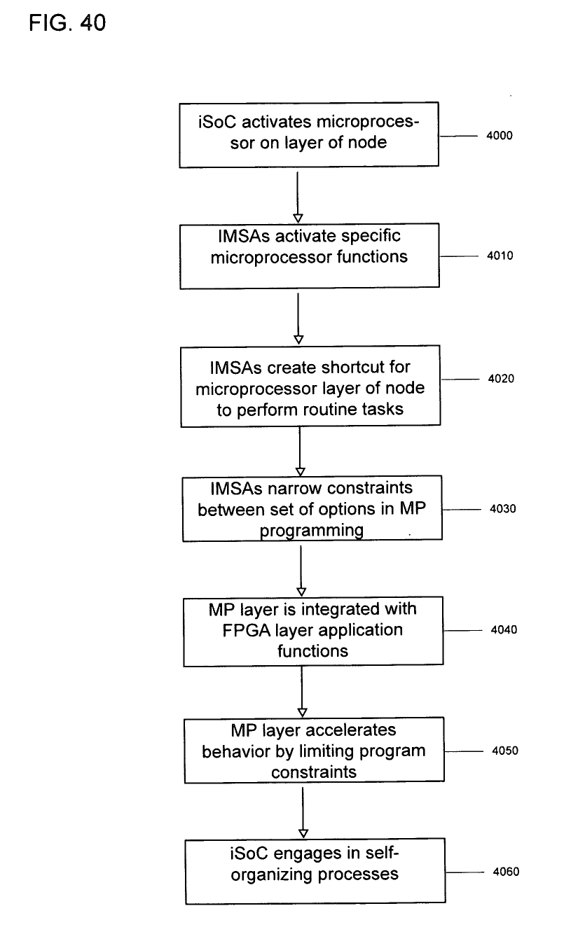

FIG. 40 is a flow chart showing the self-organizing processes of multiple IC layers in 3D nodes in a 3D SoC. After the iSoC activates a microprocessor on a layer of a node (4000), the IMSAs activate specific microprocessor functions (4010). The IMSAs create a shortcut for the microprocessor layer of node to perform routine tasks (4020) and narrow constraints between set of options in the microprocessor programming (4030). The MP layer is integrated with FPGA layer application functions (4040) and accelerates behavior by limiting program constraints (4050). The iSoC then engages in self-organizing processes (4060).

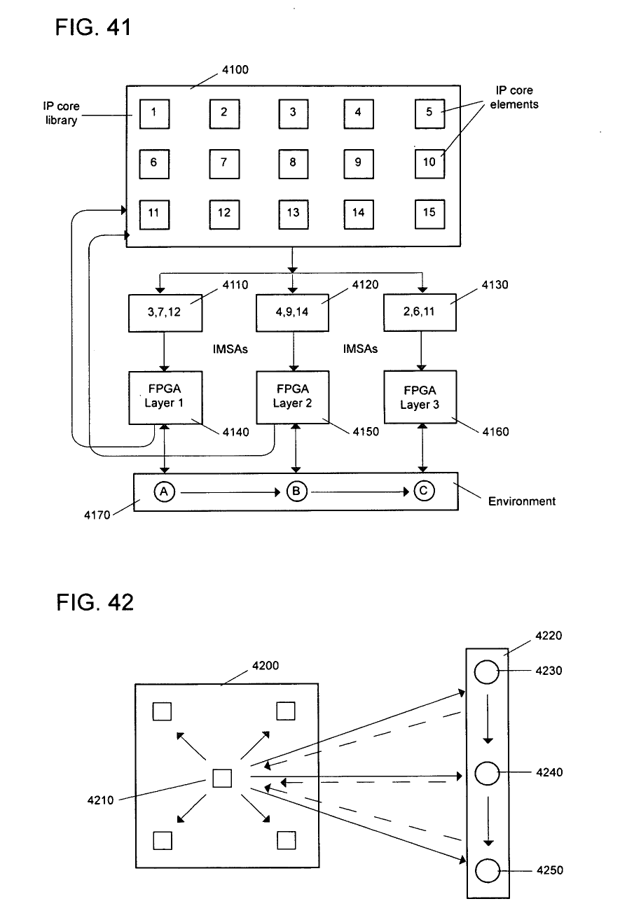

FIG. 41 shows the use of IP core elements combined for each of several adaptive FPGA layers of a multilayer IC as they interact with an evolving environment. The IP core library (4100) contains IP core elements (1-15) which recombine in different ways (3, 7 and 12 at 4110, 4, 9 and 14 at 4120 and 2, 6 and 11 at 4130). The aggregated sets of IP core elements are then applied to FPGA layers 1 (4140), 2 (4150) and 3 (4160). The FPGA layers control devices that interact with an evolving environment (A-C) (4170). The feedback from the environment requires the FPGAs to request new combinations of IP core elements at the IP core library, so the process repeats until the problems are solved.

FIG. 42 shows the interaction of an iSoC center core with both internal network and an evolving environment. The iSoC center node (4210) interacts with the neighborhood nodes as they send and receive data flows. As the environment (4220) evolves from position 4230 to 4240 to 4250, the iSoC receives feedback that requires it to transform the structure of its hardware to solve problems in the environment.

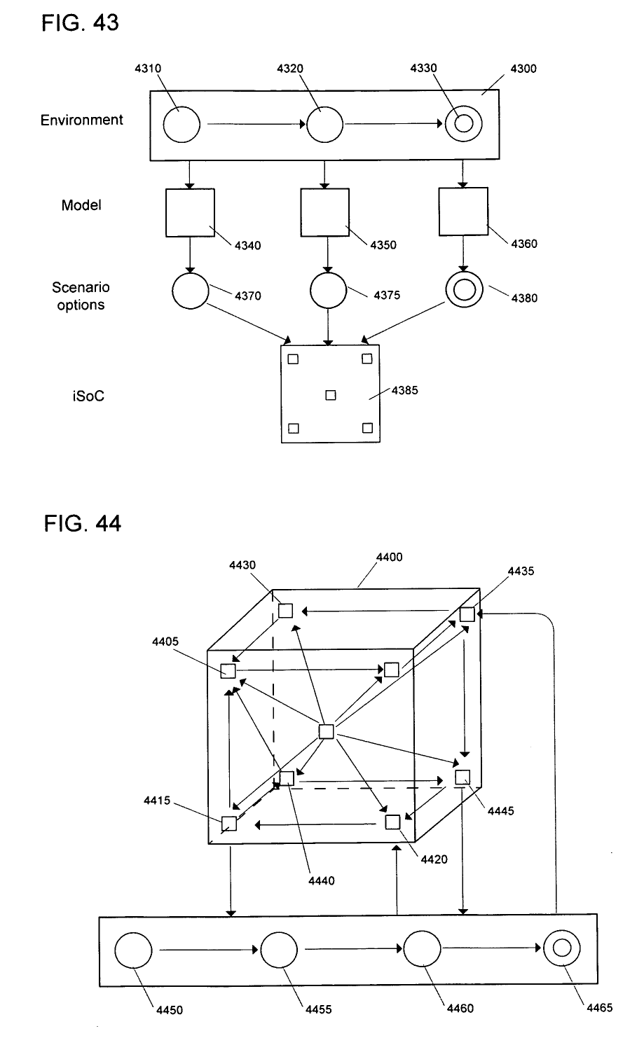

FIG. 43 shows the process of applying modeling scenarios to solve eMOOPs in a SoC. The system generates models (4340, 4350 and 4360) by tracking the evolving environment (4300) at different phases (4310, 4320 and 4330). From the models, the system generates scenario options (4370, 4375 and 4380) which are input into the iSoC for analyses of solutions to the eMOOPs.

FIG. 44 shows the internal and external interaction dynamics of a 3D SoC as it interacts with an evolving environment. The multiple nodes (4405-4445) in the SoC (4400) process data traffic as they interact with the evolving environment (4450-4465).

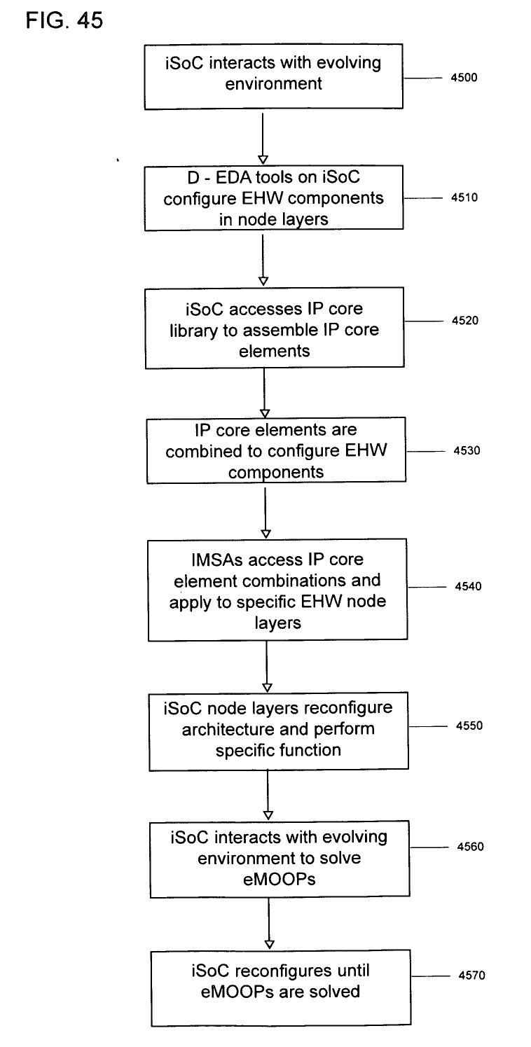

FIG. 45 is a flow chart showing the use of EDA and IP cores to solve MOOPs in a 3D SoC. After the iSoC interacts with an evolving environment (4500), D-EDA-tools on the iSoC configure EHW components in node layers (4510). The iSoC accesses the IP core library to assemble IP core elements (4520) in unique combinations, which are used to configure EHW components (4530). The IMSAs access IP core element combinations and apply these to specific EHW node layers (4540), which reconfigure architecture and perform a specific function (4550). The iSoC interacts with the evolving environment to solve eMOOPs (4560) and reconfigures until the eMOOPs are solved (4570).

I claim:

1. A system for organizing three dimensional IC nodes in a three dimensional system on a chip, comprising:
a set of thirty four nodes organized in eight neighborhood clusters;
a central core node;
wherein each neighborhood cluster consists of at least one corner node and at least one inner node;
wherein the inclusion of a particular set of neighborhood clusters is variable;
wherein the central core node controls the assignment of nodes to the specific neighborhoods at any particular time; and
wherein when the computational task requirements change, the configuration of the specific neighborhood clusters change to include a different set of nodes from two to eight nodes.

2. A system of claim 1, wherein:
The individual neighborhood clusters operate autonomously within a network by using interconnects; and
The individual neighborhood clusters interact with each other in a network by using interconnects.

3. A system of claim 1, wherein:
The central multi-layer hybrid IC node controls different neighborhoods in the 3D SoC by using a specific layer for each neighborhood cluster;
The central node solves MOOPs on specific layers and allocates the solutions to specific neighborhoods by distributing the MOOPs to the most efficient resources within each neighborhood cluster; and
The central nodes receive feedback from the neighborhood clusters.

4. A system for organizing three dimensional IC nodes in a three dimensional system on a chip, comprising:
a set of multi-layer hybrid IC nodes organized to exchange data;
wherein the multi-layer hybrid IC nodes exchange data between layers on the same device;
wherein different layers of a multi-layer hybrid IC exchange data with other layers of other multi-layer hybrid ICs in the 3D SoC;
wherein the 3D SoC employs intelligent mobile software agents (IMSAs) to exchange program code from one logic device on one layer of a multi-layer hybrid IC node to a device on another layer of a multi-layer hybrid IC node;
wherein the IMSAs are contained in a multi-agent system (MAS) in the 3D SoC; and
wherein the IMSAs exchange data and negotiate to complete computational tasks to perform multiple processes in the 3D SoC simultaneously.

5. A system for claim 4, wherein:
The IMSAs perform autonomic computing functions of self-diagnosis, self-repair and self-management in the 3D SoC;
The central node of the 3D SoC controls autonomic processes;
The IMSA collective organizes tasks for system regulatory processes;
The IMSAs generate program code to perform tasks in specific neighborhood clusters;
The IMSAs move from the central node to neighborhood nodes;
The multi-layer hybrid IC nodes perform tasks to solve MOOPs; and
The central node tracks regulatory processes and records the system performance in a database.

6. A system of claim 4, wherein:
Multi-layer FPGA nodes restructure the geometric configurations of their layers to optimize solutions to MOOPs;
Information about the multi-layer FPGA reconfigurations are organized and transmitted by IMSAs;
IMSAs use metaheuristics to model specific multi-layer FPGA nodes;
Information about the most recent multi-layer FPGA architecture configuration and functionality are transmitted to multi-layer hybrid nodes;
The 3D SoC shares tasks between multi-layer FPGA components in nodes;
IMSAs reprogram multiple hardware components to solve MOOPs; and
The multiple MOOPs are simultaneously solved by multiple evolvable multi-layer FPGA nodes.

7. A system of organizing multi-layer hybrid ICs in a 3D SoC, comprising:
IMSAs configured to aggregate IP core elements into specific customized configurations to solve specific MOOPs in real time;
Wherein the aggregated IP core elements are applied to FPGA layers of multi-layer hybrid IC nodes as they interact with an evolving environment;
Wherein the FPGA layers change their geometrical configuration of at least one logic block array interconnects in order to modify their architecture to optimally solve the evolving MOOPs;
Wherein the FPGA layers activate a device application;
Wherein the device application receives feedback from the evolving environment;
Wherein the IMSAs continue to intermediate between the modeling functions of the 3D SoC to solve MOOPs and apply the solution candidates to D-EDA placement and routing architectures that are integrated into IP core element combinations; and
Wherein when the 3D SoC interacts with the evolving environment, the SoC continuously adapts its reconfigurable hardware components on layers of multi-layer hybrid IC nodes to solve MOOPs and continuously reactivate device functions.
